(19) United States
(12) Patent Application Publication
(10) Pub. No.: US 2013/0065542 A1
(43) Pub. Date: Mar. 14, 2013

(54) Spectral Filtering Systems

(71) Applicant: Vassili P. Proudkii, Edmonton (CA)

(72) Inventor: Vassili P. Proudkii, Edmonton (CA)

(73) Assignees: Cavitid, Inc.,, Edmonton, AB (CA); Sky Holdings Company, LLC, Warrenton, VA (US)

(21) Appl. No.: 13/579,211

(22) PCT Filed: Feb. 16, 2011
(86) PCT No.: PCT/US11/24963

§ 371 Date: Nov. 27, 2012

Related U.S. Application Data
(60) Provisional application No. 61/282,463, filed on Feb. 16, 2010.
(60) Provisional application No. 61/344,702, filed on Sep. 16, 2010.

(51) Int. Cl. H04B 1/10; H04W 88/02

(52) U.S. Cl. 455/78; 327/551

(57) ABSTRACT

A spectral transform system includes a first path having a signal input, a signal output, and an adjustable first path signal scaling block. A second path is connected to the forward path between the signal input and the signal output. The second path has an adjustable delay element and an adjustable second path signal scaling block. A detector is connected to the signal output for detecting properties of an output signal. A controller is connected to adjust the delay element, the second path signal scaling block, and the first path signal scaling block based on the properties detected by the detector to achieve a desired output signal.

### CROSS-REFERENCE TO RELATED APPLICATIONS

This application claims the benefit of priority from U.S. Provisional Application No. 61/282,463, filed Feb. 16, 2010, and U.S. Provisional Application No. 61/344,702, filed Sep. 16, 2010. The foregoing related applications, in their entirety, are incorporated herein by reference.

### FIELD

This disclosure relates to spectral transform systems that may be used, for example, as a band-pass or band-stop filter in an electrical system and to methods related to the use and manufacture of such systems.

### BACKGROUND

Certain types of regenerative feedback circuits have been used for decades to increase the amplification of a signal. An example of such a circuit is disclosed in U.S. Pat. No. 1,907,653 (Muth) entitled “Short Wave Receiver”, which uses a vacuum tube and a feedback inductor to create the feedback loop.

### SUMMARY

Certain embodiments relate to an apparatus comprising a front-end circuit, that may be implemented in a monolithic integrated circuit.

Certain embodiments relate to an apparatus comprising a front-end circuit that may be implemented exclusive of a ceramic-filter or a SAW filter.

Certain embodiments relate to an apparatus for processing an electrical signal comprising a front-end circuit consisting essentially of a first path having a signal input for receiving an unfiltered signal, a signal output, and an adjustable first path signal scaling block; a second path connected to the first path between the signal input and the signal output, the second path having an adjustable delay element and an adjustable second path signal scaling block; a fixed gain block located in the first path and connected between a second path input and a second path output connected to the first path; a detector connected to the signal output for detecting properties of an output signal; and a controller connected to adjust the delay or phase shifting element, the second path signal scaling block, and the first path signal scaling block based on the properties detected by the detector to control the filtering and amplifying characteristics of the front end circuit. In certain embodiments, at least the delay element, the second path signal scaling block, and the first path signal scaling block are located on the same monolithic integrated circuit as the fixed gain block.

Certain embodiments relate to a monolithic integrated circuit comprising an input for receiving an electrical signal; a first path having a signal input for receiving the unfiltered signal, a signal output, and an adjustable first path signal scaling block; a second path connected to the first path between the signal input and the signal output, the second path having an adjustable delay element and an adjustable second path signal scaling block; and a fixed gain block located in the first path and connected between a second path input and a second path output connected to the first path. In certain embodiments, the monolithic integrated circuit may be configured to communicate with a detector connected to the signal output for detecting properties of an output signal; and a controller connected to adjust the delay element, the second path signal scaling block, and the first path signal scaling block based on the properties detected by the detector to control the filtering and amplifying characteristics of the front end circuit.

Certain embodiments relate to a transceiver implemented on a monolithic integrated circuit comprising an input for receiving an electrical signal; a first path having a signal input for receiving the unfiltered signal, a signal output, and an adjustable first path signal scaling block; a second path connected to the first path between the signal input and the signal output, the second path having an adjustable delay element and an adjustable second path signal scaling block; and a fixed gain block located in the first path and connected between a second path input and a second path output connected to the first path. In certain embodiments, the monolithic integrated circuit may be configured to communicate with a detector connected to the signal output for detecting properties of an output signal; and a controller connected to adjust the delay element, the second path signal scaling block, and the first path signal scaling block based on the properties detected by the detector to control the filtering and amplifying characteristics of the front end circuit.

Certain embodiments relate to a semiconductor chipset comprising a first monolithic integrated circuit, comprising an input for receiving an unfiltered signal; a first path having a signal input for receiving the unfiltered signal, a signal output, and an adjustable first path signal scaling block; a second path connected to the first path between the signal input and the signal output, the second path having an adjustable delay element and an adjustable second path signal scaling block; and a fixed gain block located in the first path and connected between a second path input and a second path output connected to the first path. The chipset further comprises a second monolithic integrated circuit comprising a detector connected to the signal output for detecting properties of an output signal; and a controller connected to adjust the delay element, the second path signal scaling block, and the first path signal scaling block based on the properties detected by the detector to control the filtering and amplifying characteristics of the front end circuit.

Certain embodiments relate to a method for stabilizing a regenerative feedback circuit, the method comprising: providing a controller for controlling a regenerative feedback circuit comprising a fixed gain block; an input attenuation control; a loop gain control; and a loop delay. In certain embodiments, the controller may be connected to adjust the input attenuation control, the loop gain control and the loop delay based on the properties measured by a detector to continuously monitor and control the filtering and amplifying characteristics of the circuit.

Certain embodiments relate to a method of producing a lower cost electronic device comprising providing a front-end circuit comprising a regenerative feedback circuit comprising: a fixed gain block; an input attenuation control; a loop gain control; a loop delay; and a controller connected to adjust the input attenuation control, the loop gain control and the loop delay based on the properties measured by a detector to control the filtering and amplifying characteristics of the front end circuit. In certain embodiments at least the input attenuation control, the loop gain control and the loop delay are located on the same monolithic integrated circuit as the fixed gain block.

Certain embodiments relate to a method for producing a front-end circuit on a single monolithic integrated circuit comprising fabricating a monolithic integrated circuit for filtering and amplifying an unfiltered signal, the monolithic integrated circuit comprising an input for receiving an unfiltered signal; a first path having a signal input for receiving the unfiltered signal, a signal output, and an adjustable first path signal scaling block; a second path connected to the first path between the signal input and the signal output, the second path having an adjustable delay element and an adjustable second path signal scaling block; and a fixed gain block located in the first path and connected between a second path input and a second path output connected to the first path. In certain embodiments the monolithic integrated circuit may be configured to communicate with a detector connected to the signal output for detecting properties of an output signal; and a controller connected to adjust the delay element, the second path signal scaling block, and the first path signal scaling block based on the properties detected by the detector to control the filtering and amplifying characteristics of the front end circuit.

Certain embodiments relate to a method for manufacturing an electronic device comprising fabricating a monolithic integrated circuit for filtering and amplifying an unfiltered signal comprising an input for receiving an unfiltered signal; a first path having a signal input for receiving the unfiltered signal, a signal output, and an adjustable first path signal scaling block; a second path connected to the first path between the signal input and the signal output, the second path having an adjustable delay element and an adjustable second path signal scaling block; and a fixed gain block located in the first path and connected between a second path input and a second path output connected to the first path. In certain embodiments the monolithic integrated circuit may be configured to communicate with a detector connected to the signal output for detecting properties of an output signal; and a controller connected to adjust the delay element, the second path signal scaling block, and the first path signal scaling block based on the properties detected by the detector to control the filtering and amplifying characteristics of the electronic device. In certain embodiments the method further comprises coupling the monolithic integrated circuit directly to an input.

Certain embodiments relate to a method for processing an incoming electrical signal to obtain a desired gain and selectivity at a desired frequency using a regenerative feedback circuit located on a monolithic integrated substrate. In certain embodiments the regenerative feedback circuit comprises a fixed gain block; an input attenuation control; a loop gain control; a loop delay or phase shift; and a controller connected to adjust the input attenuation control, the loop gain control and the loop delay based on the properties measured by a detector to control the filtering and amplifying characteristics. In certain embodiments, the method comprises setting the input attenuation control to a maximum so that no signal passes through the regenerative feedback circuit; adjusting the loop gain control and the delay to the approximate desired center frequency and bandpass using a lookup table; adjusting the loop gain control to the point where the output signal just begins to show an oscillation; adjusting the delay or phase shifter such that the center frequency is more accurate; increasing the loop gain control until the oscillation is extinguished, wherein the backoff is sufficient such that the excess noise in the passband of the BPF is negligible; decreasing the input attenuation control to allow a signal to enter the system where it is amplified through the regenerative feedback loop, and monitoring the bandwidth of the output signal generated by sweeping around the central frequency to measure the width of the bandwidth.

Certain embodiments relate to a mobile telephone comprising a transmit/receive switch; a subsampling analog-to-digital converter; and a front-end circuit coupled between the transmit/receive switch and the subsampling analog-to-digital converter, for filtering and amplifying an unfiltered signal. In certain embodiments, the front-end circuit consists essentially of a regenerative feedback circuit that may be implemented exclusive of a ceramic-filter or a SAW filter.

Certain embodiments relate to a mobile telephone comprising a transmit/receive switch; a subsampling analog-to-digital converter; and a front-end circuit coupled between the transmit/receive switch and the subsampling analog-to-digital converter, for filtering and amplifying an unfiltered signal. In certain embodiments the front-end circuit consists essentially of a regenerative feedback circuit that may be implemented in a monolithic integrated circuit.

Certain embodiments relate to a mobile telephone comprising a power amplifier; and a front-end circuit, for filtering out of band noise. In certain embodiments the front-end circuit consists essentially of a regenerative feedback circuit and the power amplifier and front-end circuit are implemented in a monolithic integrated circuit.

Certain embodiments relate to a mobile telephone comprising: a transmit/receive switch; a subsampling analog-to-digital converter; and a front-end circuit coupled between the transmit/receive switch and the subsampling analog-to-digital converter, for filtering and amplifying an unfiltered signal. In certain embodiments the front-end circuit consists essentially of a regenerative feedback circuit comprising a fixed gain block; an input attenuation control; a loop gain control; a loop delay; and a controller connected to adjust the input attenuation control, the loop gain control and the loop delay based on the properties measured by a detector to control the filtering and amplifying characteristics of the front end circuit. In certain embodiments at least the input attenuation control, the loop gain control and the loop delay are located on the same monolithic integrated circuit as the fixed gain block.

Certain embodiments relate to a mobile telephone (or base station) comprising a transmit/receive switch; a power amplifier; a subsampling analog-to-digital converter; and a transceiver circuit. In certain embodiments, the transceiver circuit comprises a front-end circuit consisting essentially of at least one a regenerative feedback circuit comprising a fixed gain block; an input attenuation control; a loop gain control; and a loop delay. In certain embodiments the mobile telephone also comprises a controller connected to adjust the input attenuation control, the loop gain control and the loop delay based on the properties measured by a detector to control the filtering and amplifying characteristics of the front end circuit. In certain embodiments at least the input attenuation control, the loop gain control and the loop delay are located on the same monolithic integrated circuit as the fixed gain block.

Certain embodiments relate to a monolithic integrated circuit comprising an input for receiving an unfiltered, unamplified signal; and an output for outputting a filtered and amplified version of the input signal. In certain embodiments, the monolithic integrated circuit exhibits a bandpass frequency response with a Q value greater than 500, where the center frequency of the bandpass filter can be adjusted to multiple frequencies within a predefined range exclusive of a local oscillator.

Certain embodiments relate to a Doppler radar, comprising an oscillator for producing a predefined frequency modulation; a transmitter antenna for transmitting the predefined frequency modulation; a receiver antenna for receiving a reflection of the transmitted predefined frequency modulation; a spectral transform system for isolating the frequency of the received reflection. In certain embodiments the spectral transform system comprises a first path having a signal input, a signal output, and an adjustable first path signal scaling block; a second path connected to the first path, the second path having an adjustable delay element and an adjustable second path signal scaling block; a fixed gain block located in the first path and connected between a second path input and a second path output connected to the first path; a detector connected to the signal output for detecting properties of an output signal; and a controller connected to adjust the delay or phase shifting element, the second path signal scaling block, and the first path signal scaling block based on the properties detected by the detector to center the spectral transform system on the received reflection. In certain embodiments the radar further comprises a receiver processor for detecting the frequency of the received reflection. In certain embodiments at least the delay element, the second path signal scaling block, and the first path signal scaling block are located on the same monolithic integrated circuit as the fixed gain block.

In certain embodiments the apparatus may be a mobile telephone. In certain embodiments the apparatus may be a cellular base station. In certain embodiments the apparatus may be a GNSS receiver. In certain embodiments the apparatus may be a wireless device. In certain embodiments the apparatus may be a wireless sensor. In certain embodiments apparatus may be a monolithic integrated receiver circuit. In certain embodiments the apparatus may be a monolithic integrated transmitter circuit. In certain embodiments the apparatus may be a monolithic integrated transceiver circuit.

In certain embodiments, the apparatus may be a monolithic integrated circuit comprising a plurality of regenerative feedback circuits. In certain embodiments, such a monolithic integrated circuit may be configured for use in a cellular base station.

In certain embodiments the apparatus further comprises a transmit/receive switch, wherein the front-end circuit may be connected to the transmit/receive switch.

In certain embodiments at least one of the first path or the second path of the regenerative feedback circuit further comprising a resonator connected to the regenerative circuit.

In certain embodiments the apparatus further comprises a power amplifier connected to at least one of the output of the regenerative feedback circuit or within the first path of the regenerative feedback circuit for amplifying an electrical signal for transmission.

In certain embodiments the regenerative feedback circuit comprises a fixed gain block; an input attenuation control; a loop gain control; a loop delay or phase shift; and a controller connected to adjust the input attenuation control, the loop gain control and the loop delay or phase shift based on the properties measured by a detector to control the filtering and amplifying characteristics of the circuit. In certain embodiments at least the input attenuation control, the loop gain control and the loop delay or phase shift are located on the same monolithic integrated circuit as the fixed gain block.

In certain embodiments the electrical signal may be encoded with digital information.

In certain embodiments the filtering and amplifying characteristics comprise the gain of the front-end and the bandwidth and center frequency selected for filtering an incoming signal.

In certain embodiments the second path may be a feedback path.

In certain embodiments the apparatus comprises multiple first paths connected to corresponding feedback paths, the first paths being connected in parallel between the signal input and the signal output.

In certain embodiments one or more of the multiple first paths further comprise a feed-forward path connected to the first path upstream from the feedback path and an output connected to the first path downstream from the feedback path; and a first path delay or phase shifting element connected between the input of the feed-forward path and an output of the feedback loop, the first path delay or phase shifting element being adjustable and connected to the controller, the controller being connected to adjust the first path delay or phase shifting element to achieve the desired signal output.

In certain embodiments the signal output of the second path comprises a signal combiner.

In certain embodiments the second path may be a feed-forward path.

In certain embodiments the regenerative feedback circuit comprises multiple first paths connected to corresponding feed-forward paths, the first paths being connected in series between the signal input and the signal output.

In certain embodiments the second path comprises a switch for switching between a feedback path and a feed-forward path configuration.

In certain embodiments the controller may be a processor that may be programmed to maintain a desired output signal.

In certain embodiments the detector may be one of a power detector, a spectrum analyzer, or combination thereof.

In certain embodiments the detector detects the signal-to-noise ratio of the signal.

In certain embodiments the first path signal scaling block may be adjusted by the controller to normalize the output signal.

In certain embodiments the first path signal scaling block comprises a block that modifies a coupling coefficient.

In certain embodiments the first path gain block may be connected to the first path between a second path input and a second path output.

In certain embodiments the first path gain block may be a variable gain amplifier.

In certain embodiments the fixed gain block may be a low noise amplifier.

In certain embodiments the apparatus further comprises a signal limiter at an input of the low noise amplifier.

In certain embodiments the detector comprises a signal processor.

In certain embodiments the signal input may be received via a coaxial cable.

In certain embodiments the signal input may be received via an antenna.

In certain embodiments the second path may be a feedback path, and an output of the feedback path may be connected to the antenna.

In certain embodiments the apparatus further comprises an antenna coupling block.

In certain embodiments the second path may be a feedback path, and the receiver further comprises a feed-forward path having an input from the first path upstream from the feedback path and an output into the first path downstream from the feedback path; and an adjustable path delay or phase shifting element connected between the input of the feed-forward path and an output of the feedback path, the path delay or phase shifting element being controlled by the controller.

In certain embodiments the second path may be connected to the first path by at least one directional coupler.

In certain embodiments the second path signal scaling block may be a block that modifies the coupling coefficient between the first path and the second path.

In certain embodiments the apparatus further comprises a signal generator that generates a predefined frequency; a first first path having a second path that may be a feed-forward path that suppresses a frequency above the predefined frequency; a second first path having a second path that may be a feed-forward path that suppresses a frequency below the predefined frequency; and first and second first paths being connected in series to the signal generator.

In certain embodiments the second path signal scaling block may be a gain block.

In certain embodiments the apparatus further comprises an up-conversion and pre-distortion stage at the signal input; and a power amplifier connected between a first path input and a first path output.

In certain embodiments the apparatus further comprises a sub-sampling ADC connected upstream of the detector, and wherein the detector comprises a signal processor.

In certain embodiments the apparatus further comprises multiple second paths connected in parallel, the delay of each second path being spaced to remove multiple harmonics of the oscillator output.

In certain embodiments the input attenuation control consists of a 0-10 dB voltage controlled attenuator. In certain embodiments the input attenuation control may be one of a 0-100 dB, 0-50 dB, 0-30 dB, 0-20 dB, 10-30 dB or 20-40 dB voltage controlled attenuator.

In certain embodiments the loop gain control consists of a 0-10 dB voltage controlled attenuator. In certain embodiments the loop gain control may be one of a 0-100 dB, 0-50 dB, 0-30 dB, 0-20 dB, 10-30 dB or 20-40 dB voltage controlled attenuator.

In certain embodiments the fixed gain block may be a low noise amplifier with about a 30 dB gain, 1 dB low noise amplifier. In certain embodiments the low noise amplifier may have a gain of about 10 db, 15 dB, 20 dB, 25 dB, 35 dB, 40 dB, 45 dB, or 50 dB.

In certain embodiments the loop delay or phase shifter may be a voltage controlled phase shifter with about a 0-360 degree phase capability. In certain embodiments, the phase shifter may be implemented as two 180 degree phase shifters or three 120 degree phase shifters, or four 90 degree phase shifters.

In certain embodiments the controller comprises a lookup table comprising settings for the input attenuation control, the loop gain control and the loop delay or phase shift to achieve a desired signal output. In certain embodiments the settings in the lookup table are predetermined. In certain embodiments the settings in the lookup table are adjusted using adaptive updating methods.

In certain embodiments the controller obtains a desired gain and selectivity at a desired frequency of the input signal by setting the input attenuation control to a maximum so that no signal passes through the regenerative feedback circuit; adjusting the loop gain control and the delay or phase shifter to the approximate desired frequency and bandpass using a lookup table; adjusting the loop gain control to the point where the output signal just begins to show an oscillation; adjusting the delay or phase shifter such that the desired frequency is more accurate; increasing the loop gain control until the oscillation is extinguished, wherein the backoff is sufficient such that the excess noise in the passband of the BPF is negligible; decreasing the input attenuation control to allow a signal to enter the system where it is amplified through the regenerative feedback loop; and monitoring the bandwidth of the output signal generated by sweeping around the desired frequency to measure the width of the bandwidth.

Certain embodiments relate to a spectral transform system, comprising a first path having a signal input, a signal output, and an adjustable first path signal scaling block. A second path may be connected to the first path. The signal input may be an antenna. The second path may have an adjustable delay element and an adjustable second path signal scaling block. A detector may be connected to the signal output for detecting properties of an output signal. A controller may be connected to adjust the delay element, the second path signal scaling block, and the first path signal scaling block based on the properties detected by the detector to achieve a desired output signal.

In certain embodiments, the second path may be a feedback path or a feed-forward path, and the second path may comprise a switch for switching between a feedback path and a feed-forward path configuration. The controller may be a processor that is programmed to maintain a desired output signal. The detector may be one of a power detector, a spectrum analyzer, or combination thereof. The first path signal scaling block may be adjusted by the controller to normalize the output signal.

In certain embodiments, the first path signal scaling block and the second path signal scaling block may each comprise a gain block or a block that modifies a coupling coefficient.

In certain embodiments, the first path signal scaling block may be a gain block, which may be connected upstream of the second path or to the first path between a second path input and a second path output, and may be a variable gain amplifier. The first path may comprise a low noise amplifier connected between a second path input and a second path output. There may be a signal limiter at an input of the low noise amplifier.

In certain embodiments, the detector may comprise a signal processor. The controller may comprise a lookup table comprising settings for the delay element, the second path signal scaling block, and the first path signal scaling block related to the desired signal output. The settings in the lookup table may be predetermined. The settings in the lookup table may be adjusted using adaptive updating methods.

In certain embodiments, the signal input may be an antenna. The second path may be a feedback path, and an output of the feedback path is connected to the antenna. There may be an antenna coupling block.

In certain embodiments, the second path may be a feedback path, and the spectral transform system may further comprise a feed-forward path having an input from the first path upstream from the feedback path and an output into the first path downstream from the feedback path, and an adjustable path delay element connected between the input of the feed-forward path and an output of the feedback path, the path delay element being controlled by the controller.

In certain embodiments, there may be multiple first paths connected to corresponding feedback paths connected in parallel between the signal input and the signal output. One or more of the multiple first paths may further comprise a feed-forward path having an input from the first path upstream from the feedback path and an output into the first path downstream from the feedback path; and a first path delay element connected between the input of the feed-forward path and an output of the feedback path. The first path delay element may be adjustable and connected to the controller, the controller being connected to adjust the first path delay element to achieve the desired signal output. The signal output may comprise a signal combiner.

In certain embodiments, there may be multiple first paths connected to corresponding feed-forward paths connected in series between the signal input and the signal output. There may be multiple second paths connected in parallel, the delay of each second path being spaced to remove multiple harmonics of the oscillator output.

In certain embodiments, the second path may be connected to the first path by at least one directional coupler. The second path signal scaling block may be a block that modifies the coupling coefficient between the first path and the second path. The spectral transform system may further comprise a signal generator that generates a central frequency, a first first path having a second path that is a feed-forward path that suppresses a frequency above the central frequency, a second first path having a second path that is a feed-forward path that suppresses a frequency below the central frequency, and the first and second first paths being connected in series to the signal generator.

In certain embodiments, there may be an up-conversion and pre-distortion stage at the signal input, and a power amplifier connected between a feedback path input and a feedback path output.

In certain embodiments, there may be a sub-sampling ADC connected upstream of the detector, and the detector may comprise a signal processor.

Certain embodiments relate to a Doppler radar, comprising an oscillator for producing a constant frequency, a transmitter antenna for transmitting the constant frequency, and a receiver antenna for receiving a reflection of the transmitted constant frequency. The constant frequency may be one of an electromagnetic or acoustic signal. There may be a spectral transform system for isolating the frequency of the received reflection. as described above. The controller may adjust the delay element, the second path signal scaling block, and the first path signal scaling block based on the properties detected by the detector to center the spectral transform system on the received reflection. A receiver processor may detect the frequency of the received reflection.

Certain embodiments relate to a method of transforming a frequency spectrum, comprising providing a system as described above; providing the controller with a target signal response having a target bandwidth, a target centre frequency, and a target gain; coupling an input signal to the signal input and detecting an output signal at the signal output; comparing the output signal to the desired signal response, and causing the controller to adjust the delay element, the second path signal scaling block, and the first path signal scaling block to provide the desired signal response.

In certain embodiments, the method may further comprise the step of calibrating the system by setting the input signal to zero, and adjusting the delay element and the second path signal scaling block to arrive at the desired pole or zero in the z-plane related to the target signal response.

In certain embodiments, the controller may comprise a lookup table for a set of desired signal responses. The controller may adjust the delay element, the second path signal scaling block, and the first path signal scaling block based on the lookup table prior to comparing the output signal to the desired signal response. The lookup table may be adjusted using adaptive updating methods.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 depicts a definition of a delay block utilizing a symbolic representation of the delay block as used herein.

FIG. 2 depicts a definition of a gain block utilizing a symbolic representation of the gain block as used herein.

FIG. 3 depicts a definition of a single zero FIR filter circuit utilizing a symbolic representation of the zero FIR filter circuit as used herein.

FIG. 4 depicts a definition of a single pole IIR filter circuit utilizing a symbolic representation of the single pole IIR as used herein.

FIG. 5 depicts a RFC feedback loop resonator circuit.

FIG. 6 depicts a RFC unit feeding back to an antenna.

FIG. 7 depicts a RFC unit feeding back to an antenna with an antenna coupling block.

FIG. 8 depicts an anti-regenerative feedback circuit (ARFC).

FIG. 9 depicts two RFC units in parallel.

FIG. 10 depicts a bandpass filter block with control signals.

FIG. 11 depicts an RFC feedback loop resonator with control signals including digital-to-analog and analog-to-digital converters.

FIG. 12 depicts a filter block that is switchable from RFC to ARFC operation.

FIG. 13 depicts a RFC filter block with antenna feedback and control unit.

FIG. 14 depicts filter blocks formed using RFC and ARFC units.

FIG. 15 depicts filter blocks formed using RFC and ARFC units.

FIG. 16 depicts a superheterodyne sampling device that provides outputs for the power detector and spectrum analyzer.

FIG. 17 depicts a wide tuning bandwidth channelizer.

FIG. 18 depicts algorithms used by the parameter controller.

FIG. 19 depicts a RFC unit with a power sensor.

FIG. 20 depicts a RFC unit with the sum block upstream from the gain control block.

FIGS. 21a and 21b depict examples of antennas connected as sum blocks.

FIG. 22 depicts a RFC unit with a limiter device in the forward path.

FIG. 23 depicts a RFC unit configured as a band stop filter.

FIG. 24 depicts multiple RFC units connected in parallel to created a bandpass filter.

FIG. 25 depicts a composite bandpass frequency response created by the circuit of FIG. 24.

FIG. 26 depicts multiple ARFC units connected in series to create a band-stop filter.

FIG. 27 depicts a composite band-stop frequency response created by the circuit of FIG. 26.

FIG. 28 depicts a directional coupler.

FIG. 29 depicts a RFC using a directional coupler.

FIG. 30 depicts a RFC with a coupling coefficient modulator.

FIG. 31 depicts multiple RFC units with directional couplers connected in series.

FIG. 32 depicts a composite bandpass frequency response created by the circuit of FIG. 31.

FIG. 33 depicts a RFC unit having multiple feedback loops connected in parallel.

FIG. 34 depicts a RFC unit with a directional coupler connected as a one way resonator.

FIG. 35 depicts multiple one way resonators depicted in FIG. 34 with multiple passband poles.

FIG. 36 depicts a two way resonator with different passband poles in each direction.

FIG. 37 depicts an ARFC unit with a directional coupler.

FIG. 38 depicts a cascade of ARFC units with directional couplers.

FIG. 39 depicts an oscillator with a cascade of ARFC units configured to act as notch filters.

FIG. 40 depicts a RFC unit in a Doppler radar circuit.

FIG. 41 depicts an alternative Doppler radar circuit using a two-way resonator.

FIG. 42 depicts a power amplifier using a RFC unit.

FIG. 43 depicts a receiver unit using a RFC bandpass filter and sub-harmonic ADC.

FIG. 44 depicts a RFC unit having directional couplers and a signal sensor in the feedback path.

FIG. 45 depicts a RFC unit in a microwave receiver.

FIG. 46 depicts a block diagram of a prior art implementation of a superheterodyne GPS receiver.

FIG. 47 depicts a block diagram of a GPS receiver based on a regenerative feedback circuit.

FIG. 48 depicts a block diagram of a multiband GNSS receiver based on a regenerative feedback circuit.

FIG. 49 depicts a block diagram of a prior art implementation of a wireless transceiver.

FIG. 50 depicts a block diagram of a wireless transceiver based on a regenerative feedback circuit.

FIG. 51 depicts a block diagram of a block diagram of a regenerative feedback circuit.

FIG. 52 depicts a block diagram of a regenerative feedback circuit implemented on a monolithic integrated circuit.

FIG. 53 depicts a block diagram of a superheterodyne receiver implemented on multiple ASICs.

FIG. 54 depicts a block diagram of a regenerative feedback circuit with a zero intermediate frequency.

FIG. 55 depicts a block diagram of a regenerative feedback circuit with a high speed 1 bit comparator.

FIG. 56 depicts a block diagram of a regenerative feedback circuit in a cellular phone.

FIG. 57 depicts the operation of a controller implementing a look up table.

FIG. 58 depicts a block diagram of a regenerative feedback circuit comprising a resonator in the first path.

FIG. 59 depicts a block diagram of a regenerative feedback circuit comprising a resonator in the second path.

FIG. 60 depicts a block diagram of a regenerative feedback circuit comprising a power amplifier.

FIG. 61 depicts a block diagram of a regenerative feedback circuit comprising an upconversion circuit and a power amplifier.

FIG. 62 depicts a block diagram of a regenerative feedback circuit implemented in a front-end circuit of a mobile telephone.

FIG. 63 depicts a block diagram of a regenerative feedback circuit implemented in a front-end circuit of a GNSS receiver.

FIG. 64 depicts a regenerative feedback circuit implemented on a monolithic integrated circuit.

FIG. 65 depicts a block diagram of an antenna coupled to a receiver.

FIG. 66 depicts a block diagram of a regenerative feedback circuit coupled to a passive antenna.

FIG. 67 depicts a block diagram of a regenerative feedback circuit coupled to a yagi antenna.

FIG. 68 depicts a block diagram of a regenerative feedback circuit coupled to an active antenna.

FIG. 69 depicts a block diagram of a narrowband receiver with a resonator circuit.

FIG. 70 depicts a block diagram of a resonator circuit with feedback.

FIG. 71 depicts a block diagram of a resonator circuit with a regenerative feedback circuit.

FIG. 72 depicts a block diagram of a resonator circuit with a coupling port and a regenerative feedback circuit.

FIG. 73 depicts a bi-directional filter with a regenerative feedback circuit.

FIG. 74 depicts an oscillator with a regenerative feedback circuit.

### DETAILED DESCRIPTION

The device described below is a filter block that may operate as a band-pass or band-stop filter that is tunable in terms of center frequency and bandwidth. It is based on a regenerative feedback loop that is electronically controlled for fast agile control of the bandwidth and center frequency of the filter. The filter block is described below primarily in terms of an electronic circuit, for example, a filter block designed for circuits operating in the microwave range of frequencies. However, it will be clear that the filter block may be implemented for other types of systems, such as optical, mechanical vibration or acoustic systems, or other systems that are frequency-based, where analogous components would be used in place of any electrical components described with respect to the examples given below. Accordingly, the device may be more broadly described as a spectral transform system, as the goal is to transform the frequency content of an input signal to a desired output signal. As will be understood from the description below, this is generally done by tuning the device to a desired center frequency and bandwidth, either as a band-pass or band-stop filter. Multiple devices may be combined in various ways to provide the desired frequency response.

As described herein, the filter block circuit may be denoted as a Regenerative Feedback Circuit (RFC). As described above, many of the terminology used below relate to electronic circuitry, however it will be recognized that analogous components may exist in other systems, such as optical, mechanical vibration or acoustic systems.

The following acronyms are used herein:

| | |
|---|---|
| ADC | analog to digital converter |
| ARFC | anti-regenerative filter circuit |
| BPF | Band Pass Filter |
| DAC | Digital to analog converter |
| DFT | Discrete Fourier Transform |
| DSP | digital signal processing |
| FB | filter block |
| GNSS | Global Navigation Satellite System |
| LUT | Look Up Table |
| MARFC | multi-anti-regenerative filter circuit |
| MRFC | multi-regenerative filter circuit |
| Q | Quality factor (filter bandwidth/center frequency) |
| RF | radio frequency |
| RFC | regenerative filter circuit |
| SH | Superheterodyne |
| S/H | sample and hold |

Below is a description of several components and definitions of functional blocks used in the RFC.

### Delay Function Block

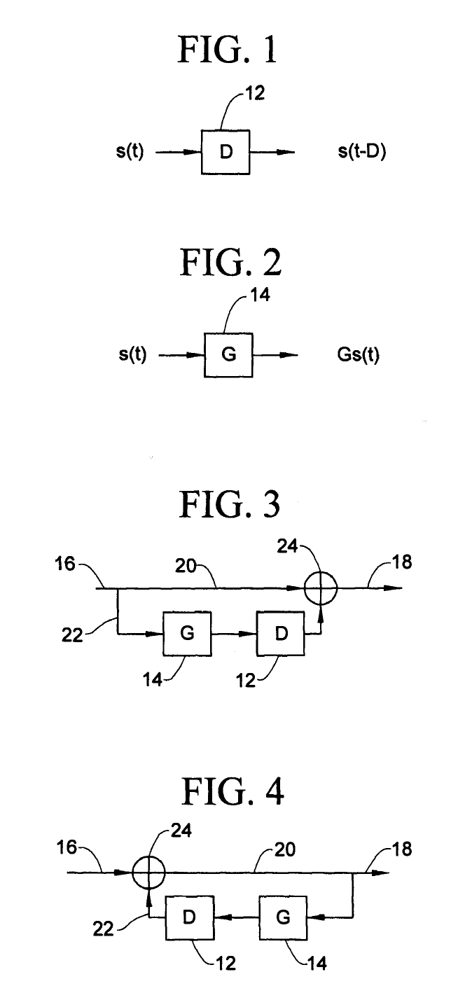

In this document, D denotes a delay block as illustrated in FIG. 1, and is identified by reference numeral 12. If the signal into the delay block is given as s(t) then the output of the delay block with a parameter D is given as s(t−D). In particular, if the input signal is a complex exponential such that

s(t)=exp(jωt)

where j≡\sqrt{−1} then the output of the delay block is

s(t−D)=exp(jω(t−D))=exp(jωt)exp(−jωD))=s(t)exp(−jωD)

Based on this, the equivalent operation of the delay block 12 of delay D is a phase shift of phase is −ωD (provided that the input excitation is a pure tone of frequency ω) In this document, the delay parameter will be a control parameter of the RFC. However, it should be understood that this is equivalent to a phase shift operation where the phase shift varies linearly with frequency.

### Gain Function Block

In this document, G denotes a gain block that scales the input signal by a scaling factor of G, and is identified by reference numeral 14 as shown in FIG. 2. In the discussion below, G is assumed to be real and positive.

### Single Transmission Zero FIR Filter Block

The finite impulse response (FIR) filter block resulting in a single transmission zero is shown in FIG. 3. The FIR filter block includes a signal input 16, a signal output 18, a first path 20, a second path 22, which is in this case a feedforward path, and a sum block 24. The first path 20 may also be referred to as a forward path, and the second path 22 may be a feed-forward path, or a feedback loop path.

The frequency response of the FIR filter is given as

H(ω)=1+G exp(−jωD)

such that when G=1 and ωD=π, H(w)=0 resulting in a transmission zero.

### IIR Filter Block

The infinite impulse response (IIR) filter block resulting in a single transmission pole is shown in FIG. 4.

The frequency response of the IIR filter is given as

$$H ( ω ) = \frac{1}{1 - G exp ( - j ω D )}$$

with the pole occurring at ω which satisfies

1−G exp(−jωD)=0

Note that the IIR filter shown in FIG. 4 is also called a regenerative feedback loop.

### Controllable Regenerative Feedback Loop

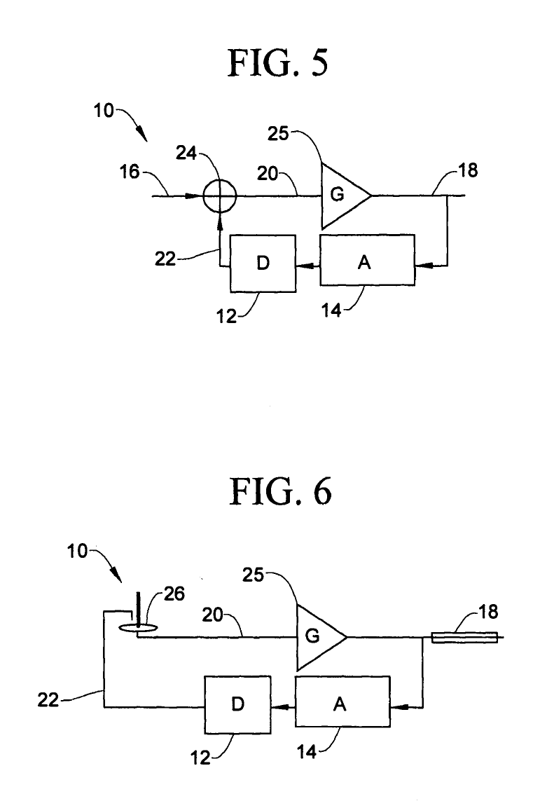

The fundamental operation of the controllable RFC, identified generally by reference numeral 10, is shown in FIG. 5 which consists of a gain stage 25 in the main through first path 20 and a series connection of a delay 12 and an attenuator 14 in the feedback second path 22 as shown. The value of the delay 12 and the attenuator 14 determine the frequency characteristics of the RFC 10.

As the gain block 14 in the feedback path has a gain between 0 and 1, it operates as an attenuator and is therefore labeled as A. The transfer function of the overall RFC 10 from the input to the output in the frequency domain is then given as

$$H ( ω ) = \frac{G}{1 - GA exp ( - j D ω )}$$

The magnitude of the signal gain through the overall RFC 10 is given as

$$\vert H ( ω ) \vert = \frac{G}{1 - GA exp ( - j D ω )}$$

The feedback loop 22 will influence the passband characteristic of the RFC 10. If A=0 then the RFC 10 will have a flat frequency response of |H(ω)|=G. As A is increased from 0 the response will have periodic resonance frequencies at

ωD=0, ±2π, ±4π, . . .

As A approaches 1/G the resonance peaks will become narrower and the overall gain will become infinitely high. In a practical application, one of the resonance frequencies (usually the fundamental at ωD=2π) is coincident with the frequency of the desired signal at the input. The frequency can be controlled by setting the delay D and the bandwidth can be set by setting A.

Referring to FIG. 6, an implementation variation of the RFC 10 in FIG. 5 is to replace the sum block 24 with an antenna 26. The signal is now assumed to be in the form of an electromagnetic radiated incident field that is intercepted by the antenna 26. A small feedback coupling is provided from the output of the feedback loop 22 that is added to the input signal via the antenna 26. Define F as the ratio of the feedback signal that is coupled back into the signal antenna 26. This is shown in FIG. 6. The operation is as with the conducted RFC 10 with the same resonance characteristics. However, A is replaced by FA, and the feedback loop 22 through the antenna coupling will add some additional delay which should be added to D 12 to characterize the frequency response of the antenna based RFC.

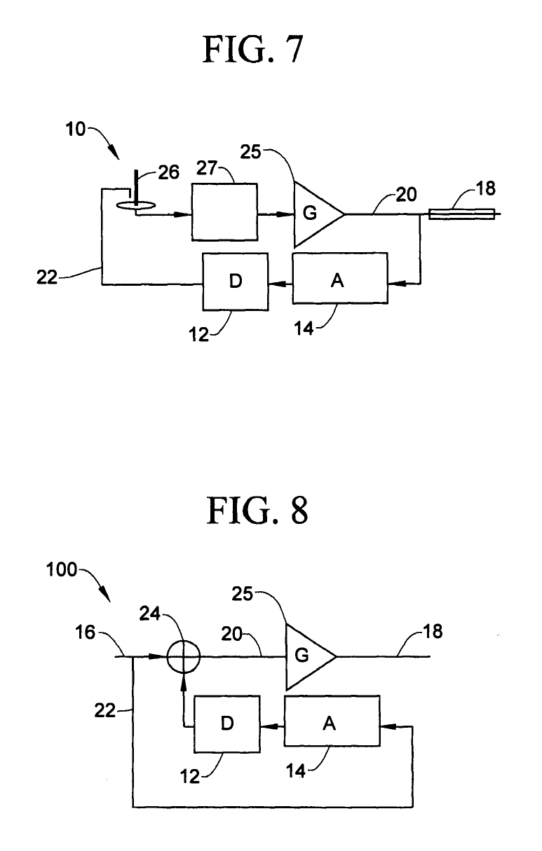

Referring to FIG. 7, the circuit shown in FIG. 6 may be modified by including an antenna coupling block 27. The antenna coupling block 27 may be integrated with the antenna 26 to make it more resonant with a higher Q. In other words, the loaded Q of the antenna 26 due to the load connection to the gain block 25 via the antenna coupling block 27 is closer to the unloaded Q of the antenna 26. The feedback in the loop 22 to the antenna 26 compensates for the gain loss of incorporating the antenna coupling.

### Anti-RFC or ARFC

Instead of using the RFC circuit 10 in FIG. 7 to create a transmission pole, it can be modified as shown in FIG. 8 to generate a transmission zero. The frequency response of this circuit is

H(ω)=G(1+A exp(−jDω))

which has a frequency notch at the frequencies of ωD=±π, ±3π, . . . .

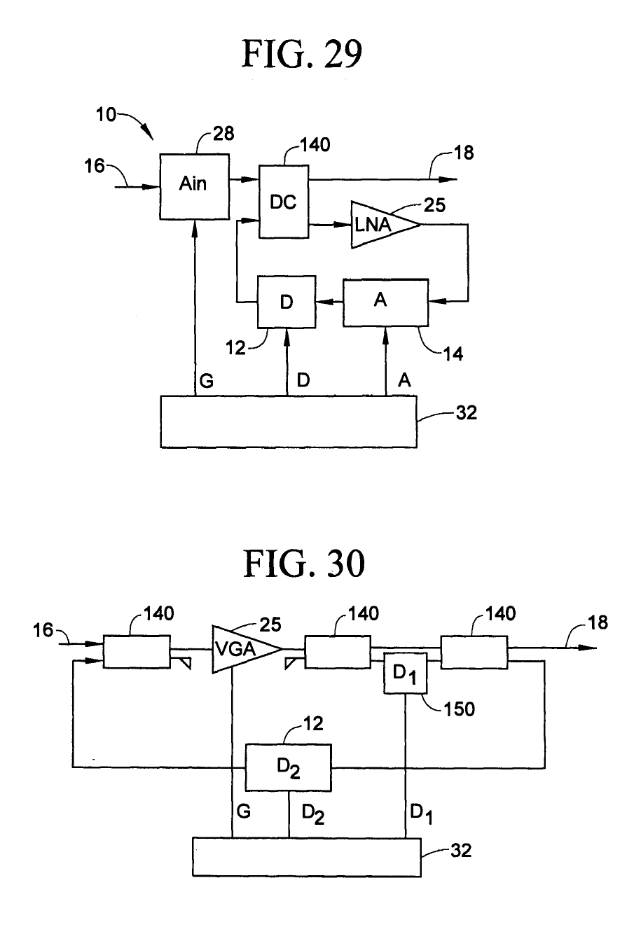

For the purposes of the discussions herein, ARFC, generally identified by reference numeral 100, is defined to imply an RFC that is reconfigured as shown in FIG. 8 to realize a transmission zero instead of a transmission pole. Note that the ARFC 100 is equivalent to a single zero FIR filter. As will be apparent from the discussion below, there are other designs that can produce a transmission zero, or notch filter, such as by using a directional coupler as shown in FIG. 29.

### Arbitrary Filter Functions

RFCs and ARFCs can be combined in parallel and series to provide arbitrary filter transfer functions consisting of multiple poles and zeros resulting in MRFC and MARFC configurations. The theory of combining poles and zeros to obtain desired filter transfer functions is known in the art, and is described, for example, in J. Proakis, D. Manolakis, “Digital Signal Processing principles, algorithms and applications”, Prentice Hall 1996, as well as other texts and articles.

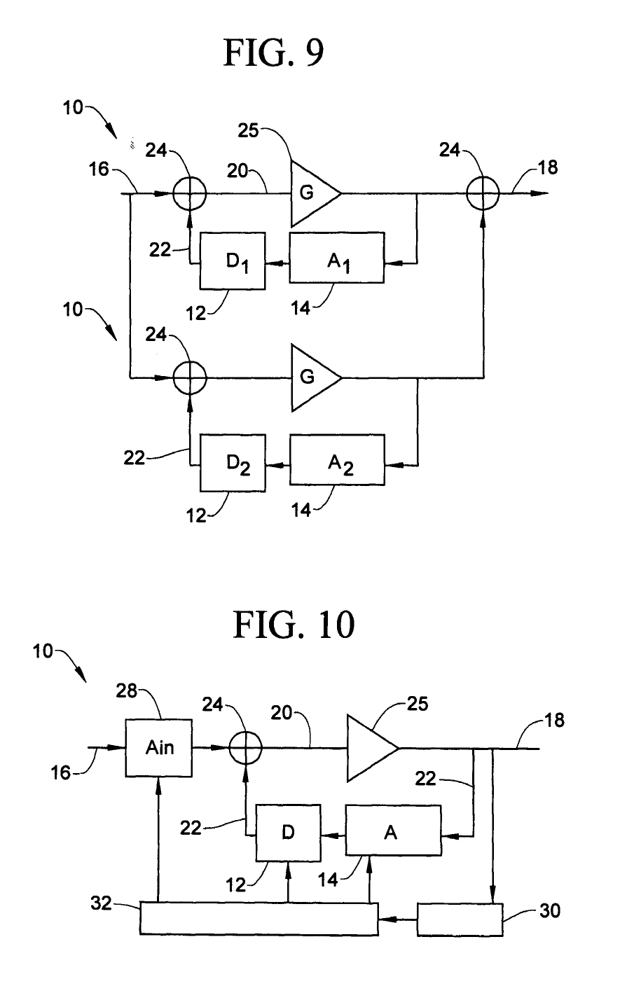

An example of a compound circuit having RFC 10 and 10′, which provides two poles is given in FIG. 9. Note that the two RFC circuits 10 are in parallel. The realization of a filter circuit with a number of transmission zeros, the arrangement would be a number of series cascaded ARFC circuits.

### RFC and ARFC as a Filter Block

The RFC and the ARFC as described above are preferably used for frequency selective filtering as required in a receiver processing of narrow bandwidth electronic signals corrupted by noise and interference. The signals could be sourced from an antenna as in a wireless receiver. However, they can be sourced from a generic block generating a narrow bandwidth signal to be isolated from accompanying noise and interference sources.

The RFC and ARFC can be used to in any application where selective frequency filtering of generic signals is required. Hence, while the embodiments described herein are for electronic signals, these signals could be of mechanical vibration, acoustic or optical origin also.

### Basic Single Element Filter Unit

FIG. 10 shows a RFC 10 that is controlled electronically by two bias voltages for the delay D 12 and the loop attenuation A 14. RFC 10 has an additional attenuator on the input denoted as Aᵢₙ and identified by reference numeral 28, a detector 30, such as a power detector, a spectrum analyzer or both, at the output port 18 that feeds back a measure of the output signal power to the controller block 32, and a controller 32 that provides electronic control of Aᵢₙ, A and D.

In certain embodiments, the circuit described in FIG. 10 may include the following exemplary components:
1. The attenuator 14 and 28 may consist of a 0-10 dB voltage controlled attenuator, such as model no. ZX73-2500 (for which a data sheet can be found at: http://www.minicircuits.com/pdfs/ZX73-2500+.pdf, the contents of which are herein incorporated by reference in its entirety).
2. The LNA 25 may consist of a 30 dB gain, 1 db low noise amplifier, such as model no. ZX60-1215LN+ (for which a data sheet can be found at: http://www.minicircuits.com/pdfs/ZX60-1215LN+.pdf, the contents of which are herein incorporated by reference in its entirety).
3. The phase shifter 12 may be a voltage controlled one with 0-180 phase capability such as model no. JSPHS-1000+ (for which a data sheet can be found at: http://www.minicircuits.com/pdfs/JSPHS-1000.pdf, the contents of which are herein incorporated by reference in its entirety).
4. The directional couplers 24 may be model no. ADC-10-1R+ (for which a data sheet can be found at: http://www.minicircuits.com/pdfs/ADC-10-1R.pdf, the contents of which are herein incorporated by reference in its entirety).

The controller 32 may be an embedded digital processing circuit, a microcontroller, a FPGA, etc. as is known in the art. The A and D controls 12 and 14 are as described before, namely providing control of the position of the pole of the RFC 10. Aᵢₙ 28 provides control of the overall throughput gain of the circuit in FIG. 10 such that the measured power of the signal output can be regulated to a desired level. Then we have the control as follows:
1. Aᵢₙ is adjusted to maintain the output power at a given threshold level
2. The A control 14 of the RFC 10 can be increased to narrow the bandwidth
3. The D control 12 can be controlled to modify the frequency.

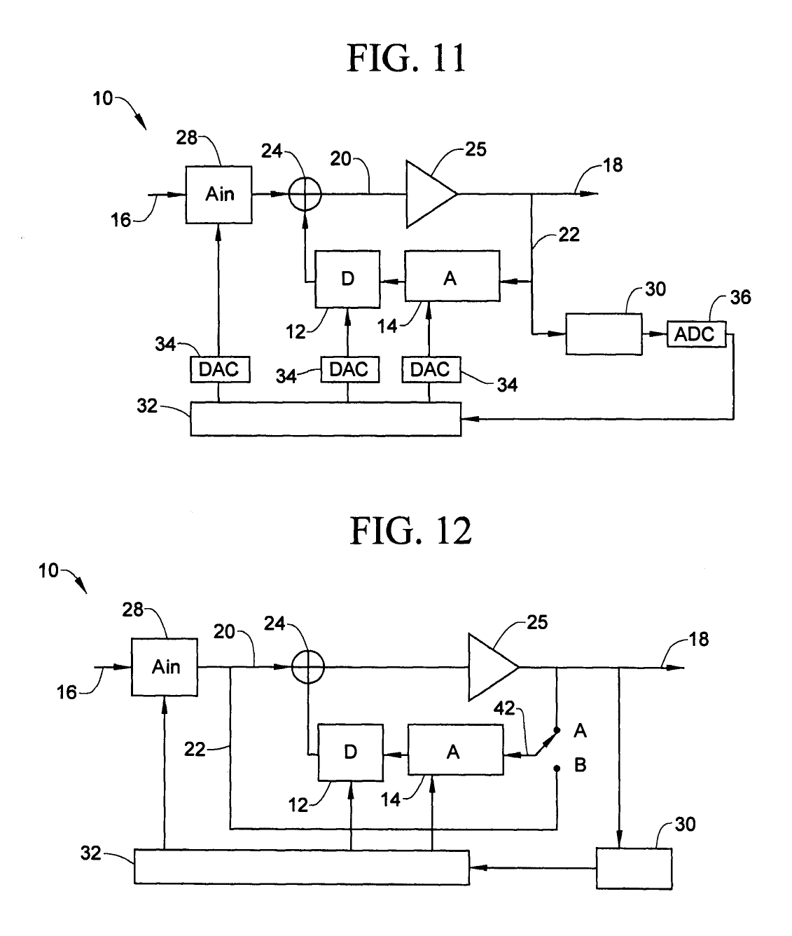

The controller 32 can be implemented as a digital signal processing unit as shown in FIG. 11. Operation is the same as in FIG. 10 except that the control processing uses a digital processing block and that the interface to the analog controls is done with DACs 34 and the input from the power detector is converted to digital with an ADC 36.

FIG. 64 shows an RFC 10 that is controlled electronically by two bias voltages for the delay D 12 and the loop attenuation A 14 on a second path 22. RFC 10 has an additional attenuator on the input denoted as Aᵢₙ and identified by reference numeral 28 on a first path 20, a detector 30, such as a power detector, a spectrum analyzer or both, at the output port 18 that feeds back a measure of the output signal power to the controller block 32, and a controller 32 that provides electronic control of Aᵢₙ, A and D via signal lines 32a, 32b, and 32c.

In certain embodiments, such as that of FIG. 64, the RFC may be implemented on a monolithic integrated circuit and configured to communicate with the detector 30 and the controller 32 (which may be an electronic controller).

The RFC unit 10 in FIG. 10 or FIG. 11 can be configured as an ARFC unit 10 by providing a switch 42 as shown in FIG. 12. With this, the overall filter element can be a bandpass filter with a single pole based on an RFC or as a notch filter with a single transmission zero based on an ARFC. FIG. 12 shows an analog configuration but a digital option can also be implemented. The switch 42 in FIG. 12 can be in position A for the RFC operation or in position B for the ARFC operation.

In certain embodiments, the procedure to obtain the maximum gain, and hence the maximum selectivity at a particular frequency whether received through an antenna or directly may be as follows:

1. Start by setting the Attenuator 28, to maximum so that no signal 16 passes through the RFC.

2. Adjust D and A to the desired BPF center frequency location via a LUT, for example. This will be approximate as the components change with temperature, aging etc. Adjust A (reduce attenuation) to the point where the output just begins to show an oscillation. The frequency of the oscillation should correspond approximately to the desired center frequency of the BPF. Adjust D (increase delay will lower frequency, decrease delay will increase frequency) such that the center frequency is accurate. Then increase the attenuation of A until the oscillation is extinguished. The backoff should be sufficient such that the excess noise in the passband of the BPF is negligible. This also creates a suitable ‘safety margin’ against spurious oscillations. Slowly decrease the attenuation at 28 and allow weak signal 16 to enter the system where it is amplified through the RFC loop

3. Monitor the bandwidth of the output signal generated by sweeping a few kHz around the central frequency to measure the width of the bandwidth, do so in another simple algorithm that detects when the bandwidth starts to expand, stop the attenuator 28 and it is at this point that the sensitivity and selectivity of the weak signal is at its highest.

4. By modifying the level of the attenuation at 14, it is possible to change the bandwidth and hence the amplitude. While changing the phase at D and the attenuation at A one can change the bandwidth and frequency of the signal respectively. Also 28 can change the overall gain of the BPF (in conjunction with 14).

In certain embodiments, the iterative algorithm (IA) may start by increasing the voltage of the attenuator A slowly till it reaches a maximum, while the Phase Shifter D is set to 0 deg. This output amplitude is that of the noise generated from the LNA 25. When a maximum is reached D is increased or decreased till that noise amplitude reaches a new maximum. Then attenuator A is increased or decreased till that noise amplitude reaches a new maximum. This is then followed by the same procedure but using the Phase shifter D and so on until just short of oscillation occurring, this can be detected in various forms, and if the oscillation occurs, a previous step can be taken back. Once a maximum has been reached, the system is ready for use.

Basic Single Element Filter Unit with Antenna Feedback

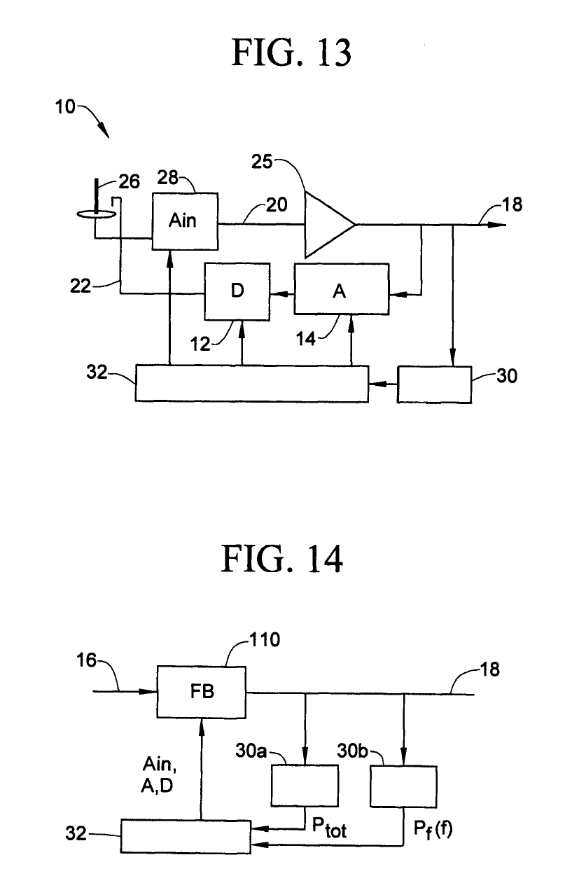

The RFC 10 requires feedback to the input of the circuit, which may be accomplished with an antenna, as shown in FIG. 13. The antenna 26, in FIG. 13 has two functions in that it intercepts the incoming radiated electromagnetic signal as well as providing a convenient means of a feedback coupling required for the RFC feedback circuit as described in the previous section (see FIG. 7). This circuit integrates the controller 32, Aᵢₙ 38 and the power detector, also referred to as a power sensor (PS) 30 as introduced in FIG. 10. Naturally, the parameter controller 32 can be replaced with the digital controller described earlier with the associated ADCs and DACs.

### Control of the Filter Unit

In order to provide the desired frequency response, Aᵢₙ, A and D for each RFC 10 or ARFC 100 block are controlled. The method of controlling Aᵢₙ, A and D to obtain the desired response will now be given. To simplify the explanation, Aᵢₙ, A and D will refer to the controls of a single RFC. However, the control processing described is applicable for multiple RFC units operating in parallel or for ARFC units. It is therefore convenient to define FB, indicated by reference numeral 110, as the overall filter block which comprised an arbitrary set of RFCs and ARFCs with control inputs of Aᵢₙ, A and D where each of Aᵢₙ, A and D can be a vector of control inputs, where the actual design of FB 110 depends on the desired filter response. That is, if there are a total of M RFC and ARFC units then there are M individual controls of D required. In this case D is assumed to consist of M control parameter elements. The FB 110 is shown in FIG. 14. The input signal 16 can be of conducted or radiated form. The output of FB 110 is the output signal 14 that passes on to further processing. The output 14 is connected with a power detector 30a and a spectrum analyzer 30b. The power detector 30a measures the total spectral power at the output of FB 110 and passes this back to the parameter controller 32. The total power is denoted as Pₜₒₜ. The spectrum analyzer 30b has the capability of measuring the power spectral density as a function of frequency given as P_{f}(f). Practical implementations of the spectrum analyzer 30b will be described shortly.

Control of Aᵢₙ

Aᵢₙ is determined by comparing Pₜₒₜ to a given threshold denoted as λ_{Ptot}. If Pₜₒₜ>λ_{Ptot} then Aᵢₙ is decreased to reduce the input gain. If Pₜₒₜ<λ_{Ptot} then Aᵢₙ is increased to increase the input gain. Conventional methods of applying an appropriate control of Aᵢₙ are used.

Control of A and D

It is assumed that the delay and gain units 12 and 14 controlled by the D and A parameters respectively are well behaved components in a circuit sense. This implies that the parameters of D and A provide an approximate monotonic control of the delay and gain functions with no discontinuities. It also implies that the resulting values of the delay and gain as a function of the D and A control inputs can be predetermined and the response curves can be stored in a look up table in the controller block. Hence the D and A controls can be set based on the calibration information stored in the lookup table to set the transmission poles of the RFCs 10 or the transmission zeros of the ARFCs 100. This lookup table will be denoted as LUT_AD.

Consequently, the desired frequency response of the FB can be mapped into the required transmission poles and zeros of the RFC 10 and ARFC 100 units respectively. Using the calibration LUT_AD, these poles and zeros can be mapped into A and D parameters that are passed onto the FB 110. The calibration required to fill the LUT_AD can be determined by conventional means of using a standard network analyzer to determine the mapping between the transmission poles and zeros and the A and D values.

It is recognized that the values of the LUT_AD will not be exact due to circuit aging, change in temperature and so forth. However it will be assumed that the values will remain approximately correct over a given time span between calibrations. The small errors will have to be corrected for as the FB unit is operating. A possible set of run time calibration corrections is given below for the RFC 10.

For the RFC 10 the following steps may be taken:
1. Set the A and D values to the desired pole location.
2. Set Aᵢₙ=0 such that no input signal is coupled into the FB
3. Increase A such that the transmission pole of the RFC crosses from the left hand plane to the right hand plane such that the output begins to oscillate at a frequency commensurate with the pole location.
4. Measure the frequency based on the spectrum analyzer shown in FIG. 14.
5. Adjust D until the oscillation frequency is consistent with the desired location of the transmission pole. While this is done, continue adjusting A such that the resonance of the oscillation is visible (ie pole is close to the jω axis)
6. Then back off A to the desired value based on the desired pole location.

For the ARFC the following steps may be taken:
1. Set the A and D values to the desired transmission zero location.
2. Set Aᵢₙ=0 such that no input signal is coupled into the FB
3. Increase A such that the transmission pole of the RFC crosses from the left hand plane to the right hand plane such that the output begins to oscillate at a frequency commensurate with the pole location.
4. Measure the frequency based on the spectrum analyzer shown in FIG. 14.
5. Adjust D until the oscillation frequency is consistent with the desired location of the transmission pole. While this is done, continue adjusting A such that the resonance of the oscillation is visible (ie pole is close to the jω axis)
6. Then back off A to the desired value based on the desired pole location.

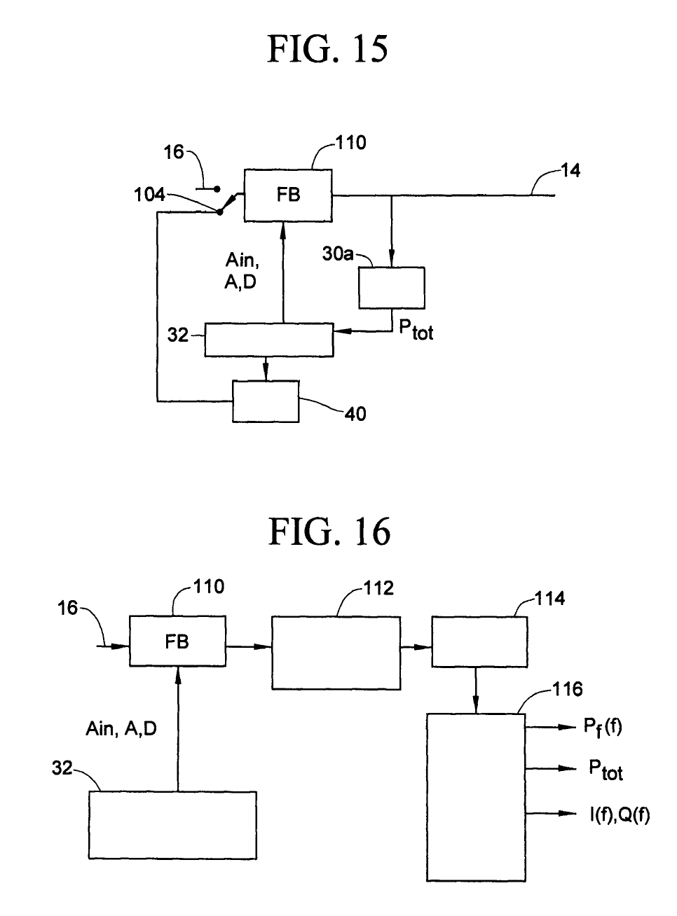

A modification to this run time calibration can be to provide a frequency signal from a synthesizer source that is connected with the parameter controller block as shown in FIG. 15. A switch 102 is now provided such that the signal at the input 16 can come from the input signal or the synthesizer 40. With this the D control can be adjusted to give the maximum response of Pₜₒₜ. The maximization of Pₜₒₜ is described in the following section. Note that the spectrum analyzer is not required in this case.

For the ARFC calibration, it is necessary to use the scheme in FIG. 15. The synthesizer 40 generates the frequency component at the desired transmission zero frequency. D and A are adjusted such that the power output Pₜₒₜ is minimized. The minimization of Pₜₒₜ is described in the section of gradient search method.

### Practical Implementation of Spectrum Analyzer

The FB 110 may be used as part of a superheterodyne receiver architecture or one that is directly sub-sampled. In either case, the baseband signal is digitized and used for further processing. Hence, there is no additional hardware required to implement a spectrum analyzer functionality at baseband. Presumably the baseband processor can accumulate N samples with a sampling rate of fₛₘₚ. The discrete Fourier Transform DFT of these N samples results in a measurement of the frequency spectrum with a frequency resolution of fₛₘₚ/N. For the application of the RFC tuning of D, the frequency corresponding to the peak can be fed back to the controller 32 shown in FIG. 14 as an estimate of the frequency corresponding to the resonance frequency of the transmission pole. For better resolution of the frequency, super-resolution methods can be used on the same set of N date samples. Such methods are well known and published. See for example: Simon Haykin, “Adaptive Filter Theory” McGraw Hill.

FIG. 16 shows a possible receiver architecture of an FB 110, downconversion and filtering (superheterodyne receiver) 112 and a baseband quantizer 114. The processing block 116, in addition to performing the functions of detector 30 described above, generates possible outputs that are used for different calibration processes of the FB. These outputs include:
{I(f),Q(f)}—quadrature phase outputs corresponding to a specific frequency component of the baseband signal.
where Pₜₒₜ is the total spectral power of the baseband signal and P_{f}(f) is the power spectral density at the frequency f.

A variant of the scheme in FIG. 16 may include the elimination of the downconversion and filtering block 112 and the replacement of the ADC sampling block 114 with a high speed subharmonic mixer and sampling block (not shown).

### Optimization Methods

For the FB 110, it is necessary to maximize P_{f}(fₒ) at a particular frequency fₒ by varying D as stated beforehand. Various methods can be used for this. One way is to compute the numerical gradient of P_{f}(fₒ) and then vary D appropriately until the gradient is zero corresponding to the maximum. Another way is to consider that the processor 116 of FIG. 16 computes P_{f}(f) for a frequency range including fₒ. D is then changed such that the maximum of P_{f}(f) corresponds to f=fₒ. Other iterative methods are possible as outlined in, for example, A. Ackleh, “Classical and modern numerical analysis theory, methods and practice”, CRC press, 2010, the contents of which are herein incorporated by reference in its entirety.

For the FB based on the ARFC it is necessary to minimize P_{f}(fₒ) at a particular frequency fₒ which involves optimizing values of both A and D. As the solution based on the LUT_AD is assumed to be reasonably close to the actual optimum point, a gradient search would be the fastest approach. The process will be to sample the I(fₒ) and Q(fₒ) outputs separately at three operating points with different values of A and D. The objective is to determine the two dimensional gradient at the current operating point denoted by {A₀,D₀} and then apply a Newton Raphson (NR) iteration at that operating point to find the next iteration. Steps are as follows:
1. Defined A₀ and D₀ as the attenuator and phase control at the current time with samples of I₀ and Q₀ for the filtered outputs of the synchronous receiver.
2. Next increase the attenuator control by ΔA such that A₁=A₀+ΔA. The phase control is the same value D₁=D₀. It is important that ΔA is in the direction towards the ‘center’ of the control of the attenuator. In either extreme the sensitivity of the control becomes very small. The output of the receiver is then sampled resulting in I₁ and Q₁.
3. Next increase the phase control by ΔD such that D₂=D₀+ΔP. The attenuator control is the same value A₂=A₀. The receiver output is sampled again resulting in I₂ and Q₂.
4. Determine the numerical derivatives as

dI_{—}dA=(I₁−I₀)/ΔA

dI_{—}dD=(I₂−I₀)/ΔD

dQ_{—}dA=(Q₁−Q₀)/ΔA

dQ_{—}dD=(Q₂−Q₀)/ΔD
5. Next a Newton Raphson update is done as follows

$${[ \begin{matrix}{A}_{0} \\ {D}_{0}\end{matrix} ]}_{new} = {[ \begin{matrix}{A}_{0} \\ {D}_{0}\end{matrix} ]}_{old} - {α [ \begin{matrix}dI\_dA & dI\_dD \\ dQ\_dA & dQ\_dD\end{matrix} ]}^{- 1} [ \begin{matrix}{I}_{0} \\ {Q}_{0}\end{matrix} ]$$

The optional factor α is a scaling that is set between 0 and 1. The functions I₀(A, D) and Q₀(A, D) are fairly smooth surfaces. Consequently, the NR method will quickly converge in a few iterations.

In some cases the manifold surface changes abruptly or there is an inflection point which causes the NR iteration to diverge instead of converge. This should not be a problem if the initial point {A₀,D₀} is sufficiently close. However, check both |I| and |Q| or I²+Q² to ensure that they have decreased in value after each NR iteration.

It is also necessary to state a tolerance for the final I²+Q² or set a fixed number of NR iterations.

Optionally, if I and Q are not available then the power detector of FIG. 15 can be used which provides an output of Pₜₒₜ(A,D). The power detector nulling will be slower to converge due to noise and bias issues. If the LUT_AD is inaccurate then a global search is required prior to a gradient type search. The global search is merely a two dimensional search over A and D. Clearly an attempt would be made to reduce the search range as much as possible.

The gradient search based on Pₜₒₜ would consist of the following steps:
1. Define A₀ and D₀ as the attenuator and phase control at the current time with a power detector sample of Gₒ=Pₜₒₜ(Aₒ,Dₒ).
2. Next increase the attenuator control by ΔA such that A₁=A₀+ΔA. The delay control is the same value D₁=D₀. Again it is important that ΔA is in the direction towards the ‘center’ of the control of the attenuator. Sample the detector signal G₁=Pₜₒₜ(A₁,D₁)
3. Next increase the phase control by ΔD such that D₂=D₀+ΔD. The attenuator control is the same value A₂=A₀. Sample the detector signal G₂=Pₜₒₜ(A₂,D₂)
4. Update the control as:

A₀→A₁ if G₁<G₀ and G₁<G₂

D₀→D₂ if G₂<G₀ and G₂<G₁

Initially ΔA and ΔD can be of moderate size. However, after several iterations, it will be determined that A₀ and D₀ are no longer changed in which case ΔA and ΔD are decreased by a factor of 2. This continues until ΔA and ΔD are on the order of the resolution of the DACs driving the A and D blocks.

Note that dynamic changes to A₀ and D₀ show up as an effective broadening of the passband or a phase/amplitude noise modulation of the passband signal with is undesirable. Hence there should be a facility for freezing the tracking such that the signal qualities can then be measured.

Next consider the FB based on the RFC for which it is necessary to maximize P_{f}(fₒ) at a particular frequency fₒ by varying A and D. As discussed before it is assumed that Aᵢₙ is set by a separate loop such that P_{f}(fₒ) is close to the threshold set. While A and D are being optimized Aᵢₙ has to be held at a constant level. Hence the steps are as follows:
1. Set the parameters A and D according to the values of the LUT_AD for the desired center frequency and bandwidth.
2. Set Aᵢₙ such that P_{f}(fₒ) attains the desired target power level.
3. Use a gradient search method for maximizing P_{f}(fo) based on varying D.
4. Adjust Aᵢₙ again such that P_{f}(fₒ) attains the desired target power level.
   There are different approaches that may be used to modify the parameters as described above, such as the LMS (least mean square) method, that are known in the art.

### Applications Using the Filter Block 110

### Mitigation of Fluctuating Coupling Characteristics of Antenna

Based on the optimization of the RFC based FB 110 as discussed in the previous sections, FB 110 may be used in different ways. FIG. 13 shows a diagram with antenna coupling 26 for an application such as a handheld cellular phone. This may be useful where the device may be in close proximity to objects that affect the antenna characteristics. Such an object could be the users head as the phone is held up to the ear. An issue is that the antenna coupling will change depending on the position of the users head relative to the phone antenna. Hence it is desired to continually adjust the parameters A and D to maximize the signal output. This is done by continually running the gradient based optimization steps as outlined in the previous section.

### Wide Bandwidth Channelizer Based on FB and Subharmonic Sampling

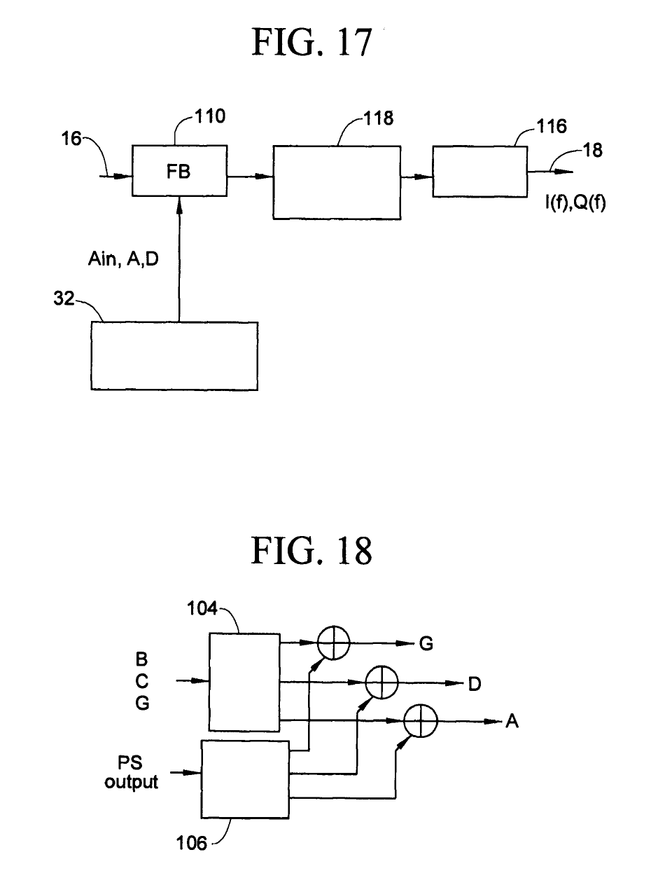

In a number of applications there is a requirement for a narrow bandwidth channelizer that can operate over a broad frequency range. The combination of the FB and a subharmonic sampling block 118 and subsequent processing provides for a means of implementing a broad bandwidth channelizer as shown in FIG. 17.

The sampling rate of the subharmonic ADC is at fₛₘₚ which is assumed to be higher than the instantaneous bandwidth of the channelizer. As the subharmonic ADC 118 aliases the frequency components of mfₛₘₚ where m is an integer, it is necessary that the bandwidth of the FB 110 be smaller than fₛₘₚ. The processing consists of a DFT of N sequential samples such that the components of

$$( \frac{n}{N} + m ) {f}_{smp}$$

can be isolated and undergo further processing.

The channelizer can be periodically calibrated based on a synthesizer output coupled through a switch into the FB as shown in FIG. 15.

### EXAMPLES

The main embodiment is shown in FIG. 10. The operation of this embodiment is as follows. The desired filter response characteristics in terms of Bandwidth (B), Center Frequency (F), and Gain (G) are communicated to the controller 32, which then set the parameters for input attenuator (Aᵢₙ) 28, delay block (D) 12 and attenuator (A) 14. The detector 30 provides feedback to the controller 32 based on the filter output 18 to fine tune the outputs Aᵢₙ, D and A.

The controller consists of two algorithms as defined in FIG. 18. The input is the set of desired response parameters {B, F, G} which are used to generate a coarse control for the outputs Aᵢₙ, D and A in block 104. In addition there is an adaptive control block 106 that uses as an input the output from the power sensor.

There are a number of variations that could also be used. The components shown in FIG. 10 present the basic functionality. They may be implemented with a variety of different components. For example the sum block (SB) 24 can be a basic passive resistor combiner, a directional coupler, power combiner, power splitter, active combiner based on a transistor gain element, integrated circuit etc. The objective of this component is that at the output it presents a linear superposition of the two inputs.

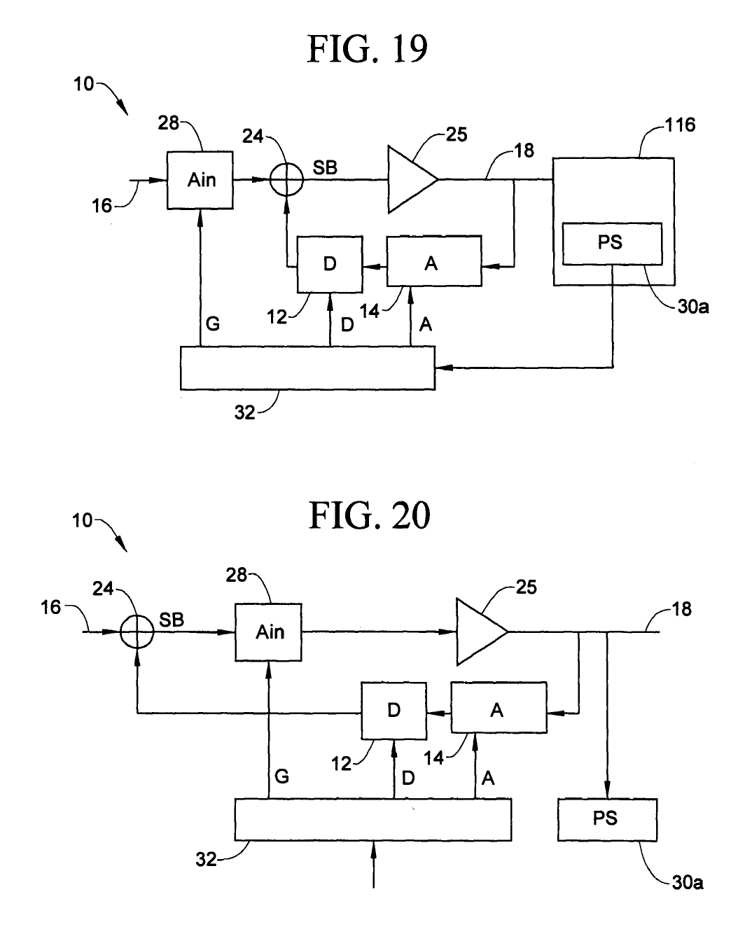

The power sensor (PS) 30a has more complex variability. One possibility is that the PS 30a is a simple wideband power detector based on a nonlinear component such as a diode. This will give the controller 32 a measurement of the power level of the output signal. The PS 30a can also be a narrow bandwidth sensor which is based on demodulation of the signal. This is shown in FIG. 19. The RFC 10 output is connected to a signal processing block 116 that extracts information from the desired signal (i.e. it could be a GPS signal or wireless communication signal). The PS functionality required (to provide feedback to the controller 32 for adaptive control) will be incorporated into the signal processing block 116 as shown in FIG. 19. The processing in this block can include power detection of the inband signal, measure of bandwidth based on the demodulated desired signal and the measure of the center frequency again based on the demodulated signal. This processing required to fulfill the PS requirements is an incremental addition to the overall processing.

Instead of a signal processing block 116, the RFC 10 may incorporate a controller 32 based on a pre-calibrated lookup table (LUT). Here the inputs {B, F, G} are mapped into the G,A,D parameter outputs based on a multi-dimensional digital LUT. The digital outputs of the LUT are converted to analog controls required for G,A,D via a set of DACs (Digital to Analog Convertors). The LUT is either filled with calibration values for the individual RFC at the time of manufacture, prior to every usage or can be adjusted based on adaptive updating methods. Such techniques are numerous and diverse, and are well known in the art. This embodiment may encompass all of the relevant, known algorithms and methods for filling, updating and maintaining such a LUT in the context of the embodiment shown in FIG. 19. When implementing this embodiment, it should be noted that prior calibration is necessary. Also, the LUT can become large as precision control is required. However there are effective ways of mitigating this issue also based on data interpolation methods.

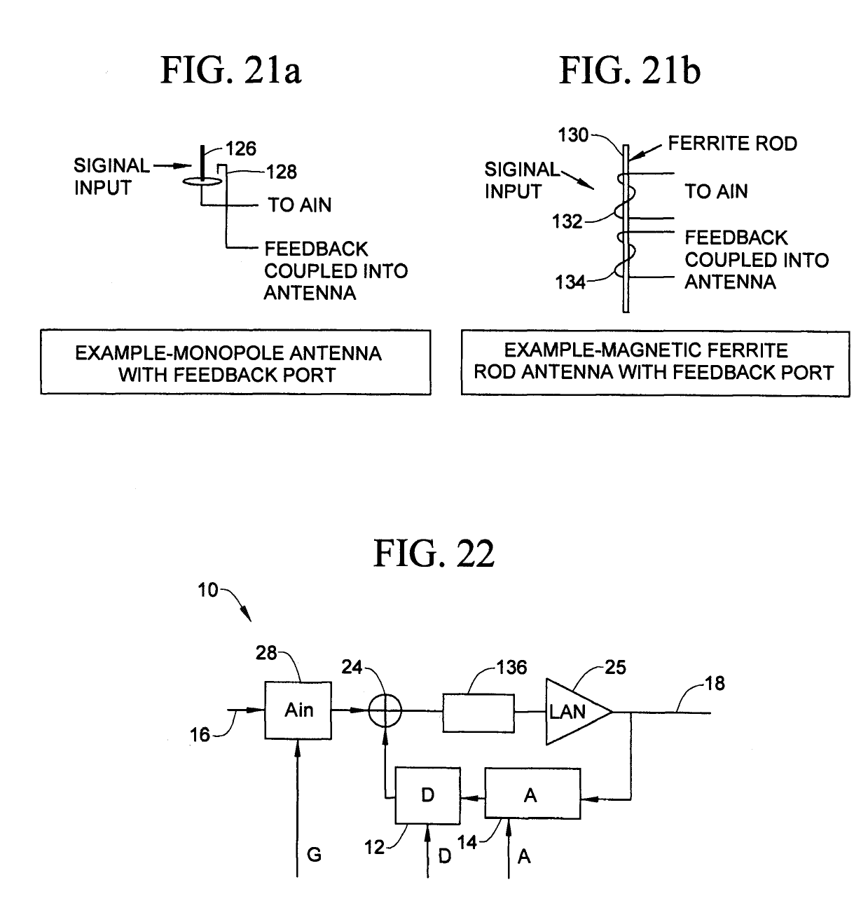

Referring to FIG. 20, in another embodiment, the SB 24 may be placed in front of the attenuator 28, and may be implemented as an antenna, two examples of which are shown in FIGS. 21a and 21b. A monopole antenna 126 with a feedback probe 128 is shown in FIG. 21a, and a magnetic ferrite rod antenna 130, where the antenna is a winding 132 about the coil and the feedback coupling is achieved by a secondary winding 134 is shown in FIG. 21b.

While a radio frequency application has been described here, the antenna SB implementation could be a sensor for optical signals or mechanical vibration with a commensurate feedback transducer. For instance the SB could be a microphone with an electrical signal output. The feedback could either be a mechanical transducer that feeds back to the microphone or it could be added as an electrical signal to the microphone. The latter would be closer to the circuit in FIG. 10 where the input signal could be sourced from a microphone giving an electrical output where a conventional SB is added after the microphone.

Referring to FIG. 22, there may be a limiter device 136 placed in front of the LNA 25. The limiter 136 is preferably an RF or microwave device that limits the instantaneous amplitude of the incoming signal from exceeding a given level. It keeps the LNA 25 out of saturation and protects it from damage. It also limits the input into the LNA 25 when the {G,A,D} controls are applied such that the RFC 10 becomes unstable and oscillates.

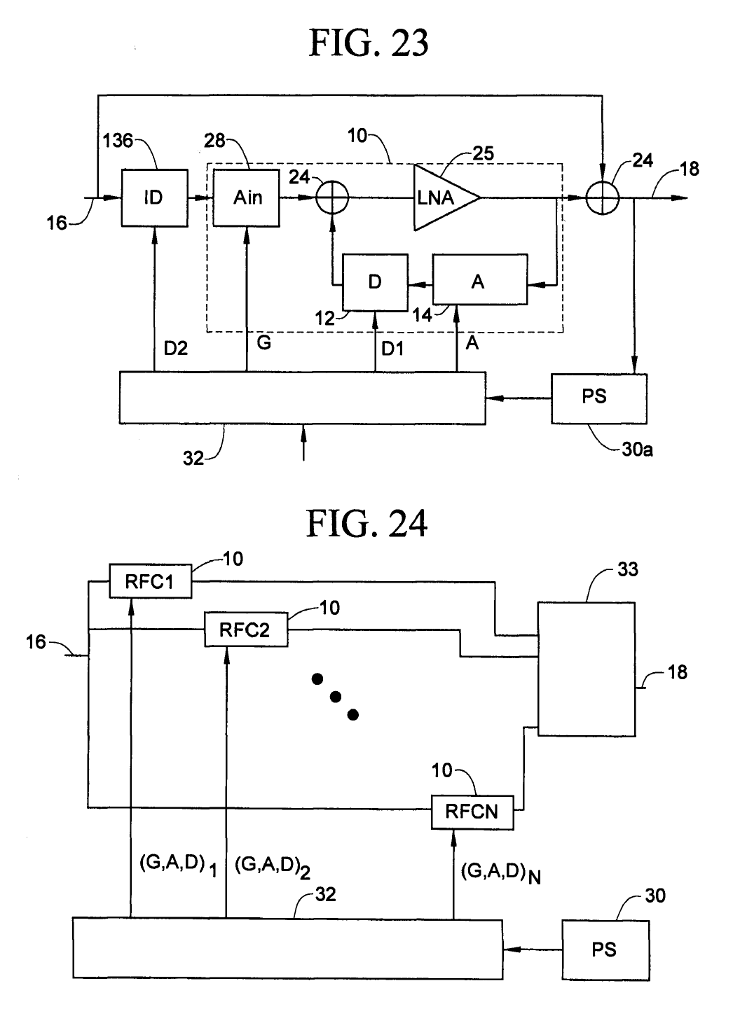

Referring to FIG. 23, the RFC 10 may be configured such that a band stop filter results instead of a bandpass filter. The RFC 10 in the figure is a bandpass filter as described previously. However, an additional delay block 136 is added on the input ‘input delay’ (ID) that is controlled by a signal D2 from the controller 32. This provides a phase shift to the RFC band pass function that is added to the direct path of the input signal 16 in a second summing block 24. Hence the band pass filter of the RFC 10 combined with the direct path constitutes a notch filter with a controllable notch depth, center frequency and bandwidth. By adjusting the controls of D2, G, D1 and A the notch can be moved anywhere in frequency with a variable depth and width. This arrangement has been referred to previously as an anti-RFC or ARFC.

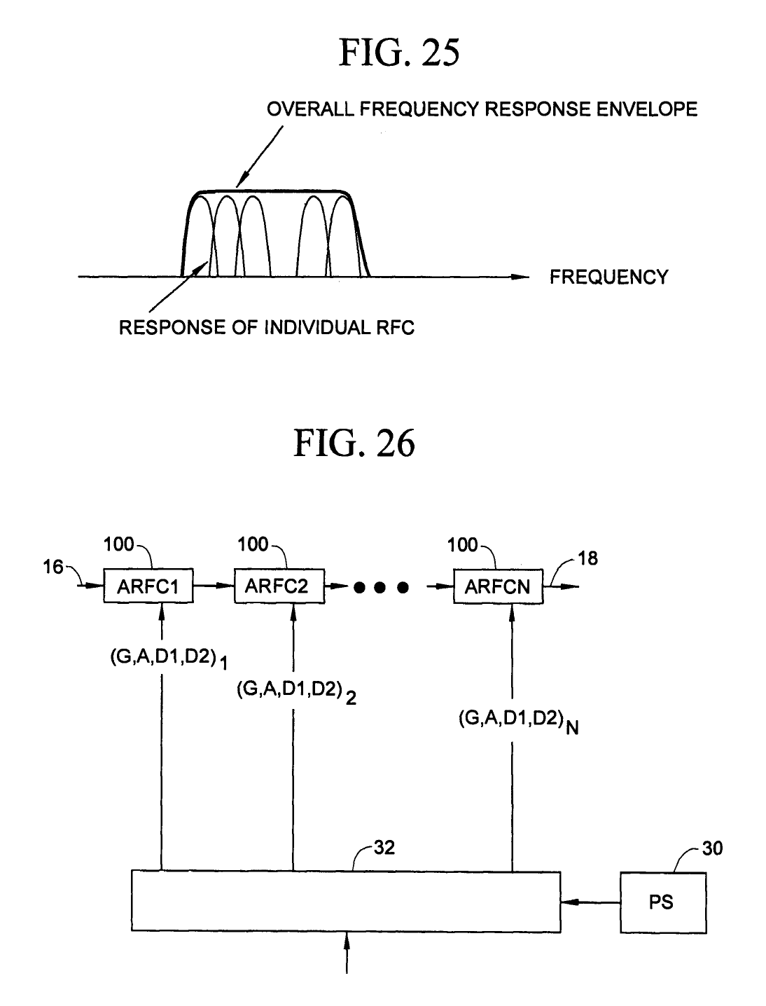

Referring to FIG. 24, several RFC units 10 can connected in parallel to realize an overall filter arrangement with multiple poles or passbands. In FIG. 24, N RFC units 10 are in a parallel configuration, with each implementing a specific frequency pole, and are combined in block 33. The poles can be arranged such that they are individual passbands separated in frequency. They can also be arranged such that they are closely spaced forming a contiguous passband as shown in FIG. 25.

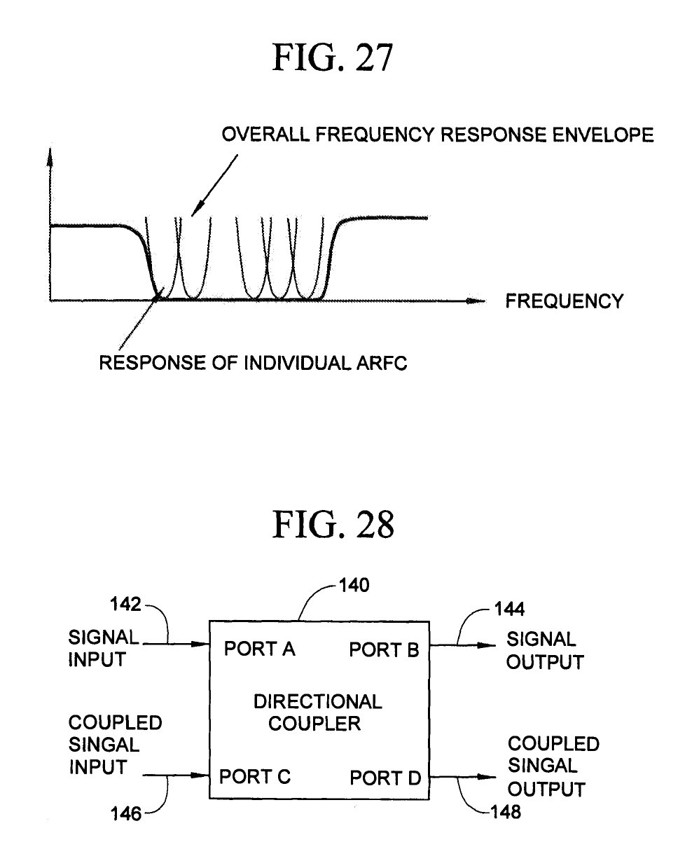

Referring to FIG. 26, several ARFC units 100 may be connected in series to realize an overall filter arrangement with multiple transmission zeros or bandstops. As shown, there are N ARFC units in a series configuration, each implementing a specific transmission zero in frequency. The transmission zeros can be arranged such that they are individual band-stop filters or notch filters separated in frequency. They can also be arranged such that they are closely spaced forming a contiguous stop-band as shown in FIG. 27.

As mentioned previously, the RFC may be implemented using a directional coupler 140, which is shown in FIG. 28. A directional coupler (DC) is a 4 port passive circuit component, which will be described in the context of an RFC. Referring to FIG. 29, an example of an RFC 10 that include a directional coupler 140 is shown. In the depicted example, the directional coupler 140 preferably has a specific coupling ratio. The signal into port A 142 is coupled with negligible excess loss to the output port B 144. Likewise the signal input to port C 146 is coupled to the output port D 148 with negligible excess loss. A small proportion of the signal into port A 142 is coupled into port D 148 but not into port C 146. Likewise a small proportion of the signal into port C 146 is coupled into port B 144 but not into port A 142. This coupling from A to D and from C to B can be precisely set through the design of the DC 140. The DC 140 is a commonly used device for RF and microwave circuits and is known in the art. The DC 140 is used instead of the sum block shown previously. An advantage of this embodiment is that a precise amount of coupling from the main signal path into the recalculating loop can be used.

Referring to FIG. 30, in one embodiment, the use of directional couplers 140 may allow the attenuator 14 to be replaced by a block 150 that modifies the coupling coefficient of the directional coupler 140. As the attenuator 14 would have a gain of less than 1, the coupling coefficient modifier 150 can provide the same function as an attenuator by varying the signal strength that is coupled into the second path 22, and can also be controlled by the controller 32. As depicted, the coupling coefficient modifier 150 is a delay element that is connected between directional couplers 140.

Also shown in FIG. 30 is a variable gain amplifier (VGA) 25, which is used to replace the input attenuator 28 and the fixed gain stage 25. The VGA 25 is connected between the input and output of the first path 20. The gain of the VGA 25 is controlled by the controller 32, such as through a modulator (not shown).

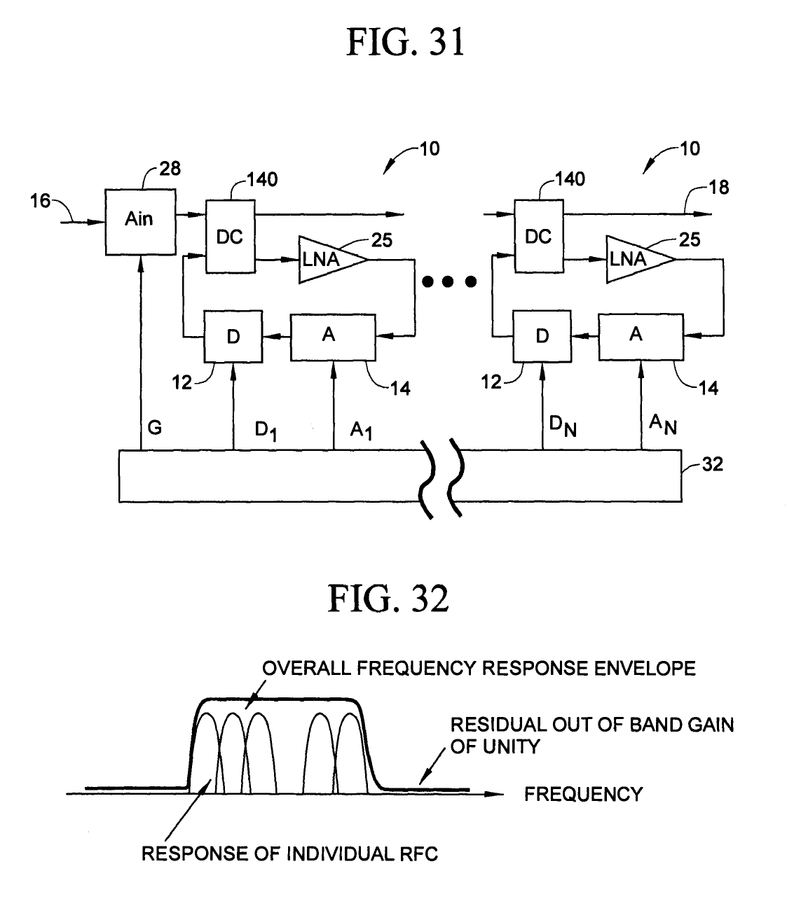

Referring to FIG. 31, there may be a multiple passband filter realization with multiple RFCs 10 connected in series that include DCs 140, and controlled by a common controller 32. A useful property of the RFC 10 as implemented with a DC 140 as in FIG. 29 is that the signal passes through the RFC 10 with unit gain if it is out of, and is amplified if it is within, the bandwidth of the resonator. Hence, a multiple passband arrangement can be implemented as shown in FIG. 31, with the frequency response shown in FIG. 32. An advantage with the circuit in FIG. 31 is that it has fewer components and controls required of the controller 32 than the other multi-RFC circuit.

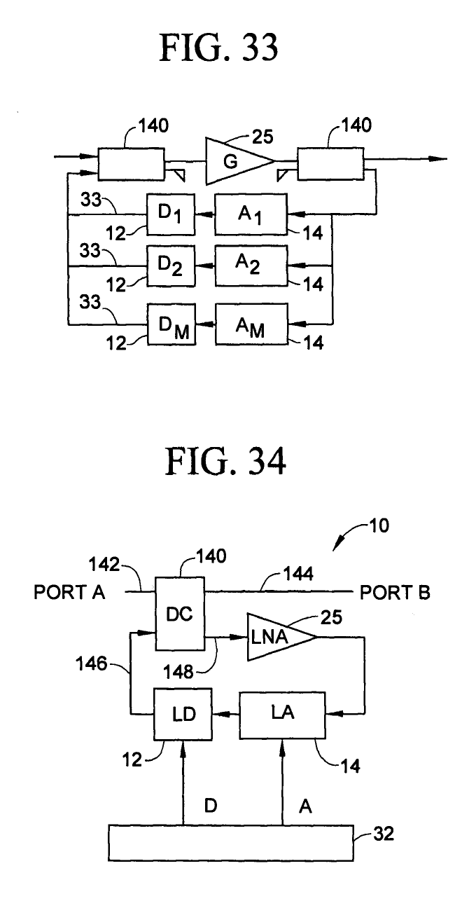

Alternatively, the structure shown in FIG. 33 may be used to create a passband filter with a frequency response as shown in FIG. 32. The structure shown in FIG. 33 may also be used to create an oscillator that suppresses harmonics. As shown, there are multiple loops 22, each with attenuator and delay elements 12 and 14. The circuit consists of a gain stage 25 and multiple parallel feedback paths 22. It will be understood that the input directional coupler 140 may be removed, which passes feedback paths 33 directly into the gain stage 25. There are M feedback paths 33, which are identified below as p₁, p₂ to p_{M}. Each path has an electrical length of Nₘ/2 wavelengths of the desired oscillation frequency where Nₘ is positive integer such that Nₘ=1, 2, 3, . . . . Associated with each path is a device that can be designed to give a specific scaling and phase shift factor. A possible implementation for such a device is a resonator cavity where the coupling to and from the cavity can be designed such that the signal path through the device has the desired scaling and phase shift.

Consider the first path and constrain the electrical length to be one half wavelength such that N₁=1. The electrical length is therefore π radians through this feedback loop. If the gain of the amplifier in the loop is −1 then the circuit with a single feedback path will oscillate at the frequency corresponding to the electrical length being π radians.

Consider the first path and constrain the electrical length to be one wavelength such that N₁=2. The electrical length is therefore 2π radians through this feedback loop. If the gain of the amplifier in the loop is 1 then the circuit with a single feedback path will oscillate at the frequency corresponding to the electrical length being 2π radians.

An issue is that the active gain stage in the loop will generate some harmonic distortion. The p₁ loop will have resonant frequencies at multiples of the intended oscillation frequency which will significantly increase the harmonic output of the oscillator.

Now consider a circuit with two parallel feedback loops. The first feedback loop has a constraint of N₁=2 and a loop gain of 1. The second loop has a constraint N₂=1 and a loop scaling of −1. The combination of these two paths is such that the frequency corresponding to an electrical length of 2π through p¹ will also have a phase of 2π through p₂ such that the oscillator will operate at this equivalent frequency but the same feedback network will not pass the second harmonic of this frequency. It can be shown that the combined feedback will have a null at all of the even order harmonics of this oscillation frequency.

Suppose p₃ is added with N₁=3, N₂=2 and N₃=1 then, with suitable gain coefficients of each of the pₘ branches, it is possible to suppress the second and third harmonic in addition to the 5^{th} and 6^{th} harmonic and so fourth.

In general if M feedback loops are used with Nₘ=M−m+1 then the harmonics of 0, 2, 3, . . . , M−1 will be suppressed. The Mth harmonic will be the first that will create an harmonic content issue. FIG. 33 shows an implementation based on using individual dielectric resonators in each of the M feedback paths. The coupling into the dielectric resonator can be adjusted such that the appropriate loop gain and phase for the individual paths is established.

Referring to FIG. 34, the RFC 10 with a DC 140 may be used as a one way resonator. When the signal is input into port A 142 with the output at port B 144, the RFC 10 is coupled in and the overall circuit behaves as a narrow bandwidth resonator with high gain in the resonant band. When the signal is coupled into port B 144 with the output of port A 142, then the circuit behaves as a low gain wide bandwidth all pass filter. The resonant band of the forward direction can be controlled in the same manner as described previously with the controller 32. Also, as the circuit is linear, signals can be simultaneously be applied to port A 142 and to port B 144 such that the circuit will simultaneously provide a high gain narrow bandpass characteristic in the forward direction (port A 142 to port B 144) and a low gain all-pass characteristic in the reverse direction (port B 144 to port A 142).

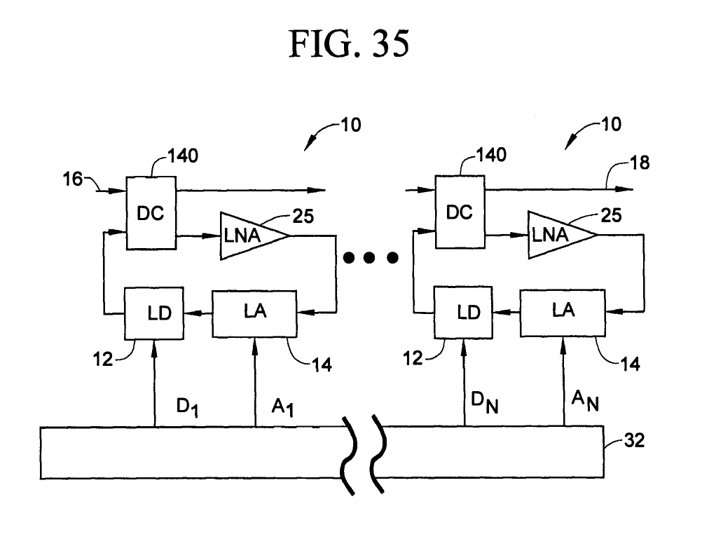

Alternatively, referring to FIG. 35, a circuit based on the RFC units 10 with the directional coupler 140 may be designed that provides a one way resonator with multiple passbands in one direction and broadband unity gain in the other direction.

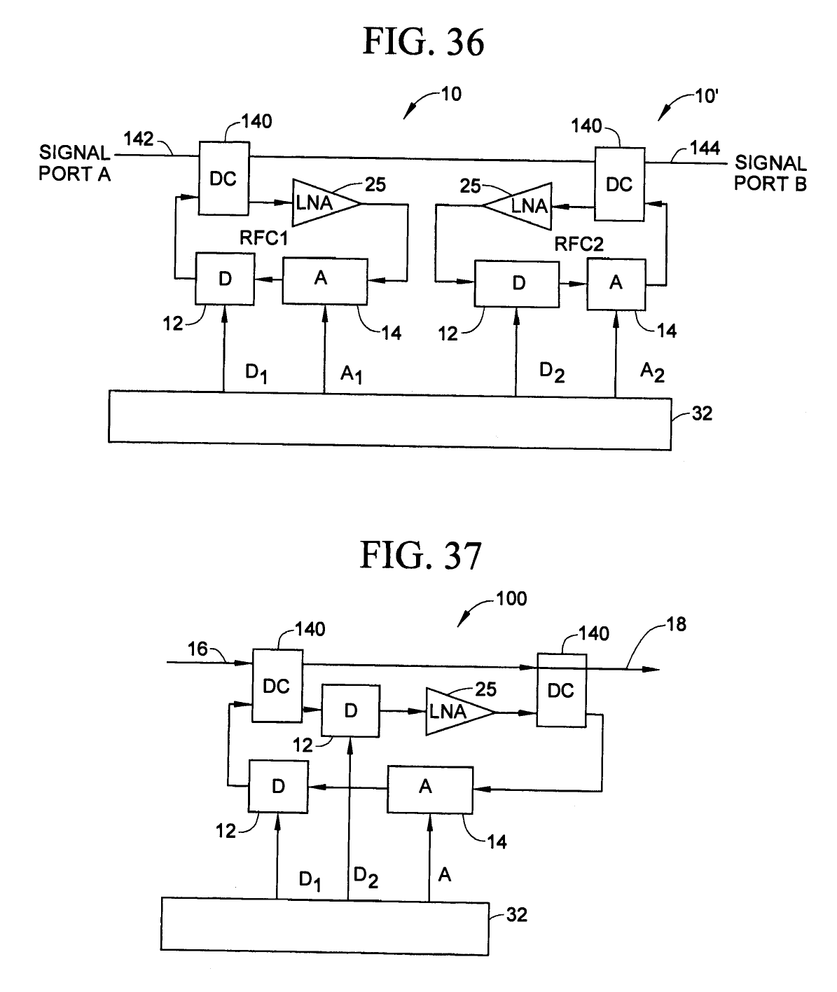

Alternatively, referring to FIG. 36, a useful circuit can be realized based on multiple RFCs 10 with DCs 140 that provide a set of passband poles in one direction and another set of passband poles in the opposite direction. This is shown for one pole in each direction in FIG. 34. For the signal into port A 142, the throughput gain will be unity across the whole frequency band in addition to the resonant passband provided by RFC1 10. The signal will be unaffected by RFC2 10′. Likewise, for the signal into port B 144, the throughput gain will be unity across the whole frequency band in addition to the resonant passband provided by RFC2 10′. The signal will be unaffected by RFC1 10.

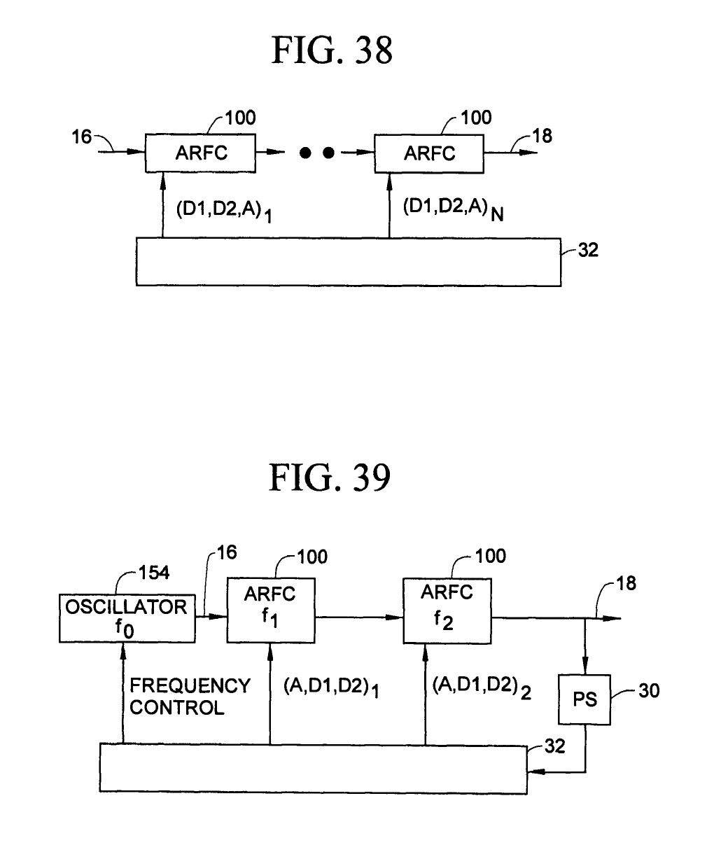

Referring to FIG. 37, the ARFC version may also be implemented with a DC 140. This results in a filter with a narrow band-stop frequency characteristic as shown in FIG. 35. The ARFC 100 uses two variable delay units 12 controlled by D1 and D2 as well as an attenuator 14 controlled by A. The total of the controls (A,D1,D2) control the center frequency, bandwidth and depth of the notch. There may also be a cascade of ARFC units 100 based on the DCs, as shown in FIG. 38. This can be used to implement an arbitrary number of transmission zeros such that an arbitrary filter shape can be realized.

Referring to FIG. 39, there may be a system that has a series cascade of two RFC based notched filters, or ARFC units 100, to provide an improved oscillator with suppressed close-in phase noise. The input oscillator 154 has a tone frequency of f₀. The two RFC notch filters 100 are tuned to f₁=f₀+Δf and f₂=f₀−Δf. The notch filters 100 will suppress a significant portion of the close in phase noise of the oscillator. The frequency control could be an analog tuning voltage for a voltage controlled oscillator (VCO) or digital input for a synthesizer based oscillator. The notch filters for f₁ and f₂ can be of the ARFC 100 variety with a sum block as in FIG. 23 or a DC 140 as in FIG. 37. The controls from the controller 32 are shown as for the DC implementation of the ARFC 100. A power sensor 30 is added to the output of the oscillator such that the power of the phase noise and oscillator spurious components can be monitored and the ARFC controls adjusted accordingly. A practical issue in this implementation is the tight control required of the setting of the controls for the two ARFC units. It will be understood that more ARFCs 100 can be added for further suppression of the oscillator phase noise and spurious components.

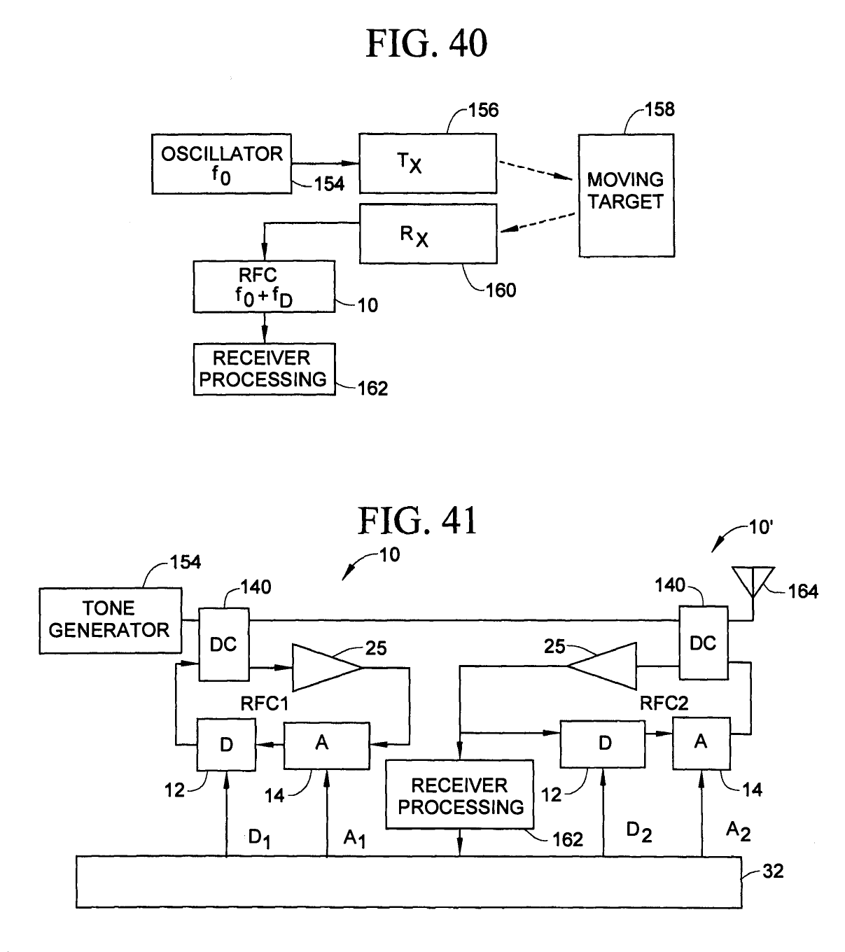

Referring to FIG. 40, the RFC 10 may be used in a Doppler radar embodiment. A continuous output Doppler radar transmits a tone of high purity via a transmit antenna 156 and detects the return signal from a moving target 158 at a relatively small frequency increment from the transmitted tone via a receive antenna 160. While the term “radar” generally implies the use of radio waves, it will be understood from the discussion herein that other types of signals, such as electromagnetic or acoustic, may also be used. The depicted device uses the RFC 10 to provide a narrow bandwidth filter centered at the return signal which is Doppler shifted in frequency. The received signal is analyzed using a processing block 162. A variation of this is shown in FIG. 41, which uses the bi-directional filter of FIG. 36. The amplified tone signal of the Doppler radar is filtered based on the RFC1 10 and connected to the antenna 164. The transmitted signal is not affected by RFC2 10′. On return, the signal is filtered by RFC2 10′ and passed to the Doppler radar signal processing 162. Note that the center frequencies of the RFC1 10 and RFC2 10′ are slightly shifted in frequency due to the Doppler shift of the return signal. The circuit in FIG. 40 is an extension of the generic Doppler radar that uses the RFC in the return path. The circuit in FIG. 41 uses a bi-directional filter with two RFCs 10 controlled by the controller 32 to extract the Doppler frequency component in the return.

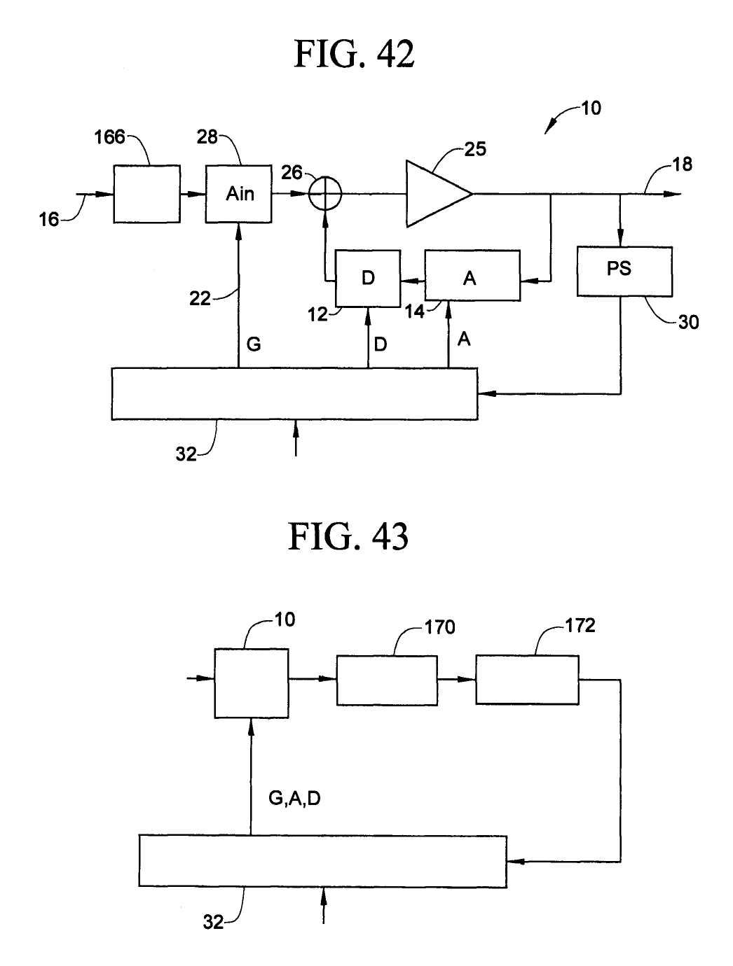

Referring to FIG. 42, the RFC 10 may be used as a narrow bandwidth power amplifier with RFC filtering. A microwave or RF power amplifier is typically used over a moderate frequency range, but the instantaneous bandwidth is very small. The RFC 10 can be used to remove much of the intrinsic noise associated with the gain block of the power amplifier. A possible circuit configuration is shown in FIG. 42. As in previous embodiments, the controls of G,A,D control the passband characteristics of the RFC band pass filter that, in this embodiment, controls the passband characteristics of the power amplifier. The input baseband signal is upconverted and pre-distortion is applied by block 166 to compensate for the subsequent frequency distortion of the RFC 10. The power sensor 30 at the output of the RFC 10 provides feedback for the controller 32 to control the G,A,D parameters, based on the desired response that is input into controller 32.

Referring to FIG. 43, the RFC 10 and controller 32 described above may be used in a receiver with a sub-sampling ADC. The RFC provides bandpass filtering at the front end of the receiver with a bandwidth that is sufficiently narrow that it is commensurate with the desired receive signal. The narrow bandpass ensures that additional anti-aliasing filtering is not required prior to the sub-harmonic sampling and receiver processing by blocks 170 and 172, respectively. As such that the combination of the RFC and the sub-harmonic sampling avoids additional filtering and signal gain components generally associated with the conventional receiver.

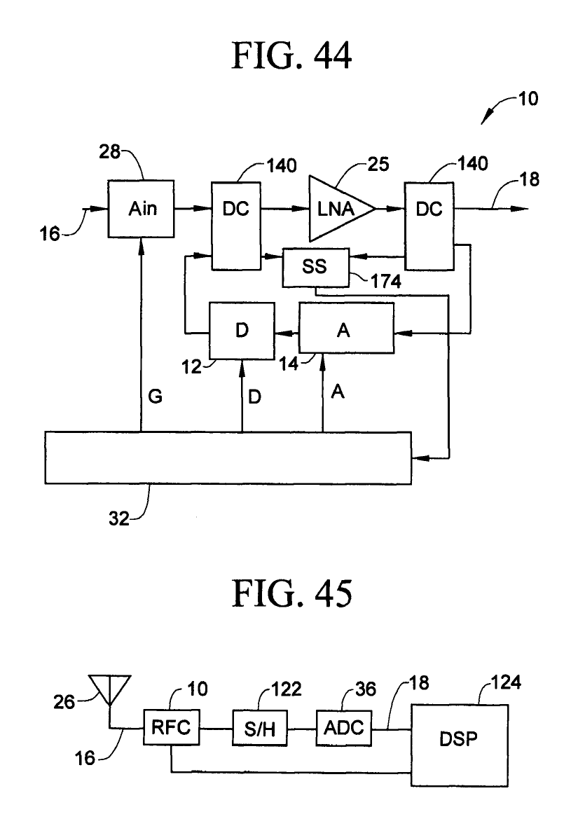

Referring to FIG. 44, a signal sensor block 174, denoted SS, may be inserted into the RFC circuit to provide feedback.

### Properties

Adjusting the controls of the RFC provides a means of realizing a frequency filtering sub-circuit that may have the following properties:
Signal throughput gain may be varied over a range from −20 dB to over 60 dB (e.g., −20-0 dB, −10-0 dB, 0-60 dB, 0-30 dB, 0-45 dB, 15-45 dB, etc.) in some embodiments with a relatively narrow frequency range commensurate with the bandwidth of a typical wireless communication signal
The ratio of the band center frequency to the bandwidth, which is the equivalent Q factor of the RFC, can vary over a broad range. In some embodiments, the range may be from less than 10 to over 100000 (e.g., 10-80000, about 90000, about 110000, about 125000, about 150000, etc.). Hence the RFC can result in extremely high frequency selectivity.
The RFC may be used to filter for a single dominant passband while minimizing the presence of spurious side bands at frequencies outside of the desired signal bandwidth.
Relative suppression of out of band signals of between 0 to 60 dB (e.g., 0-30 dB, 0-45 dB, 15-45 dB, etc.)can be achieved.
The circuit is linear and therefore the operation is independent of signal type and modulation.
The RFC is electronically tunable and hence can be quickly tuned for different signal conditions in terms of bandwidth and carrier frequency.
The RFC can be configured to operate as a tunable notch filter.
Several RFCs can be made to operate in parallel which provides for a device that can simultaneously filter signals at different frequencies. An application could be a GNSS receiver where the receiver has to simultaneously demodulate a number of discrete bands.
Several ARFCs can be configured to operate in series such that multiple discrete narrow frequency bands can be simultaneously rejected.
The RFC can be made physically very small and can be incorporated with a monolithic receiver ASIC with a minimal number of external components. Consequently, the RFC can be made as a separate packaged component or as an IP block that can be integrated onto a multifunction receiver ASIC.
The controller may use feedback from a signal strength block to help determine acceptable values for G, D and A.

Based on these properties, the RFC can be used in any microwave receiver application where the instantaneous signal bandwidth is small relative to the carrier frequency. An example of this is shown in FIG. 45, where the circuit is shown as having an antenna 26, the RFC unit 10, a sample and hold block 122, an ADC block 36, and a DSP processing block 124. A few other examples of potential applications in microwave sub-circuits and signal receivers are given below. In addition to these examples, the RFC design can be used in other system, such as mechanical vibration, optical and acoustic. As will be recognized by those skilled in the art, this may be done by substituting analogous elements for those described in the examples herein.

The RFC can be used to replace narrow bandwidth microwave bandpass filters. Highly selective bandpass filters at microwave frequencies are generally bulky and have a limited range of tuning. The RFC provides a physically small solution to this implementation problem with a tunable Q and center frequency.

The RFC can simplify the implementation of an image rejection mixer. A typical image rejection mixer can provide up to 20 dB of relative image band suppression while the RFC can provide up to 60 dB. Further, the typical bulky image rejection mixer is avoided.

The RFC can implement a highly selective highly agile microwave bandpass filter which is useful in numerous applications such as frequency hopping radar systems and communication receivers.

In the case of a GPS system, GPS receivers require low noise RF front ends with high selectivity to remove out of band interference signals. The RFC can provide suppression of up to 60 dB (e.g., 40 dB, 50 dB, 45 dB, 60 dB, etc.) of out of band signals. This simplifies the development of a standard heterodyne receiver as the linearity requirements of the down conversion stage can be relaxed since the potentially large out of band signals have been removed by the RFC. Also in the superheterodyne context, the RFC dispenses with the requirement for an image rejection mixer. The RFC can also be effectively used in a zero IF implementation of the GPS receiver. The typical issues with second order nonlinearities are reduced with the RFC implementation due to the high selectivity of the RFC. The same comments would be applicable for any generic GNSS receiver.

Terrestrial wireless receivers as those in typical cellular handsets are prone to interference from large signals in the vicinity of the desired passband signal. The RFC's high selectivity is effective in suppressing these out of band signals. This reduces the linearity requirements of the receiver down conversion and IF stages, potentially resulting in a less expensive and lower power consumption receiver implementation.

Typical frequency agile or frequency hopping radars are subject to unintentional as well as hostile jamming. As a result, highly frequency selective receiver front ends are required to suppress the interference signals. The RFC can be electronically tuned to perfectly track the instantaneous signal bandwidth of the frequency hopping radar signal with very high selectivity.

There is a potential application of the RFC for very low noise microwave amplifiers as required in more esoteric areas such as radio astronomy. The RFC could be implemented with the LNA for the realization of a tunable, highly frequency selective extremely low noise amplifier with a noise figure as low as 0.2 dB (e.g., 0.1 dB, 0.15 dB, 0.2 dB, 0.25 dB, 0.3 dB, 0.35 dB etc.) without the requirement of cryogenic cooling.

The fast electronic tunability of the RFC provides opportunities for adaptive receiver applications. Feedback from the output receiver processing can be conveniently linked back to the RFC to realize various forms of adaptive filter implementations.

The high selectivity of the RFC suggests that the intermediate frequency filtering used in a standard superheterodyne receiver is not required. A simplified architecture for a wireless receiver is then as shown in FIG. 45. The desired bandpass signal received from the antenna is directly filtered by the RFC. The output of the RFC is then sampled in time by the sample and hold unit (S/H). The output of the S/H is subsequently quantized by the ADC with the resulting digital format output further processed by the digital signal processing (DSP) block. The DSP block also provides control outputs for the RFC.

### An Application of the RFC for GPS and Cellular Transceivers

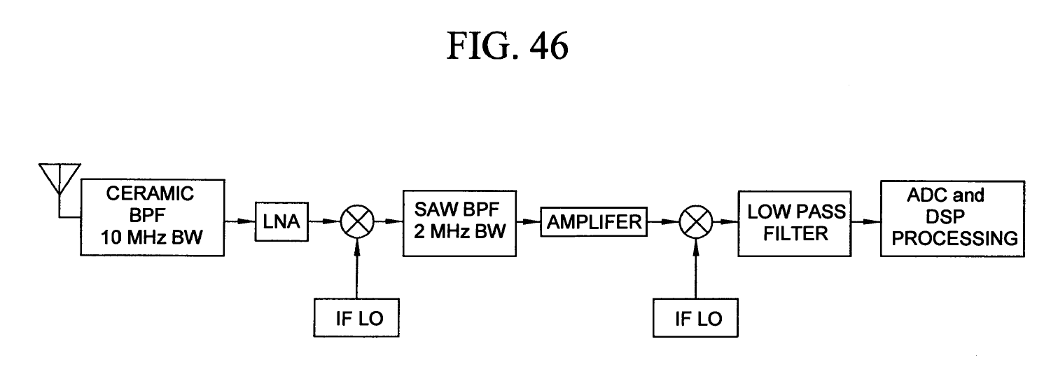

The typical GNSS receiver (of which the GPS is a common example) consists of a superheterodyne structure where the bandwidth of the receiver is progressively narrowed as the signal passes through the receiver. In addition the filtering becomes more selective in terms of suppressing out of band interference signal components. A generic block diagram of this prior art implementation is shown in FIG. 46 which is an example of a superheterodye (SH) GPS receiver

An integration implementation issue with this type of receiver is the requirement of the two local oscillator blocks as well as the ceramic and SAW (surface acoustic wave) filters. It is generally necessary to implement these components off the main processing chip adding to the cost and size of the overall circuit. In addition off chip components reduces the reliability of the receiver.

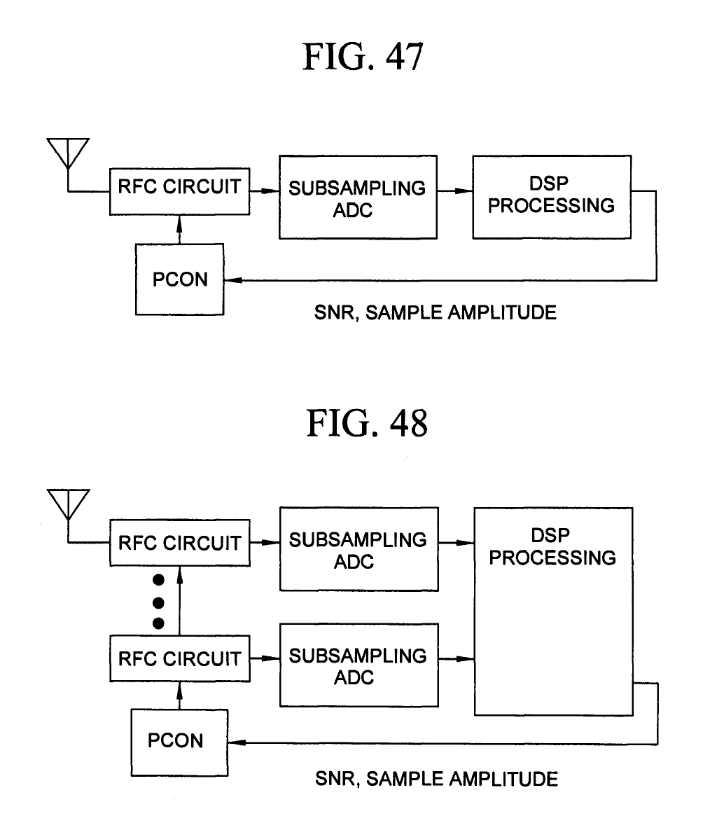

The GPS receiver implementation based on the RFC is shown in FIG. 47. The entire filtering and gain required for the GPS RF signal processing is provided by the RFC where the control variables are provided by the parameter control (PCON) block. In this exemplary embodiment, the output of the RFC is the RF at the GPS L1 carrier frequency of 1.57542 GHz. This is digitized by the sub-sampling ADC as shown. The sampling rate is commensurate with the utilized bandwidth of the GPS signal which is typically about 2 MHz for the C/A code signal and 10 MHz for the P code. The digitized output samples of the ADC are processed in the same manner as a conventional GPS. This processing results in the measure of the magnitude of the ADC samples as well as an estimate of the signal to noise ratio (SNR) of the received GPS signals from the various satellites that are visible. The magnitude of the digitized signal samples is fed back to the PCON such that the gain through the RFC can be adjusted. As well the SNR estimates of the processed received GPS signals are used by the PCON to adjust the bandwidth and center frequency of the RFC. Typically this is achievable by a dithering algorithm with the objective of optimizing the SNR's of the processed GPS signals.

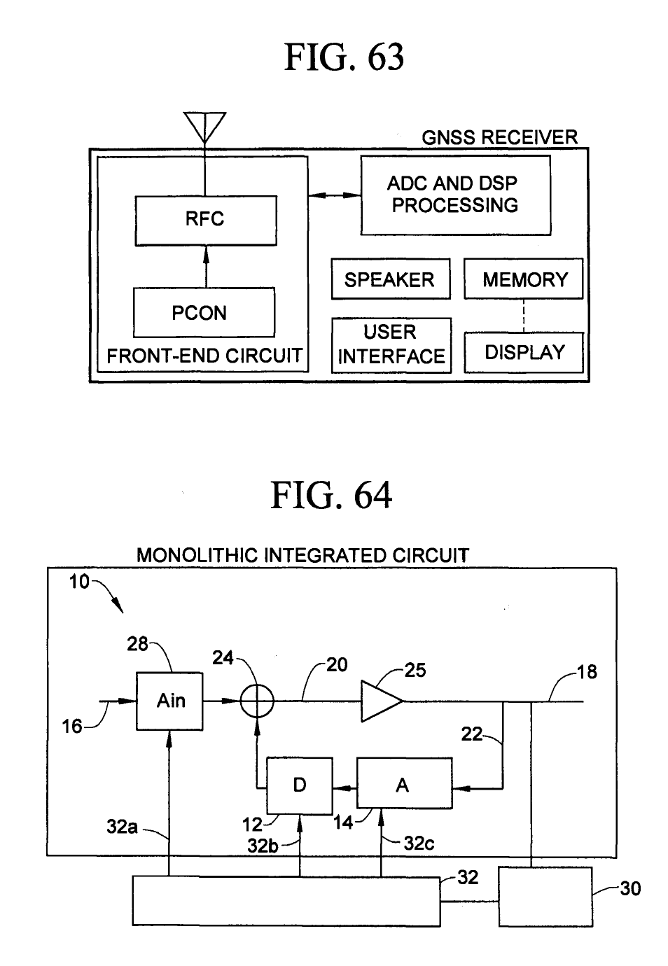

FIG. 63 depicts a block diagram of a regenerative feedback circuit implemented in a front-end circuit of a GNSS receiver. As shown, the front-end of the GNSS receiver may include an RFC circuit and a PCON for receiving GNSS signals such as the GPS signals. The received signal would then be sent to the ADC and DSP so the necessary information could be extracted and utilized appropriately.

A multiband GNSS receiver simultaneously processes the signals from various GNSS satellites and potentially pseudo-lite sources. The circuit in FIG. 47 can be extended for such a multiband case as shown in the exemplary circuit in FIG. 48. As shown, an RFC circuit is provided for each of the GNSS frequency bands of interest, each of which is controlled by the PCON. A sub-sampled ADC associated with each RFC circuit provides digitized samples that the DSP processing uses to compute the estimates of the sample magnitude and the SNR's associated with each of the GNSS satellite sources.

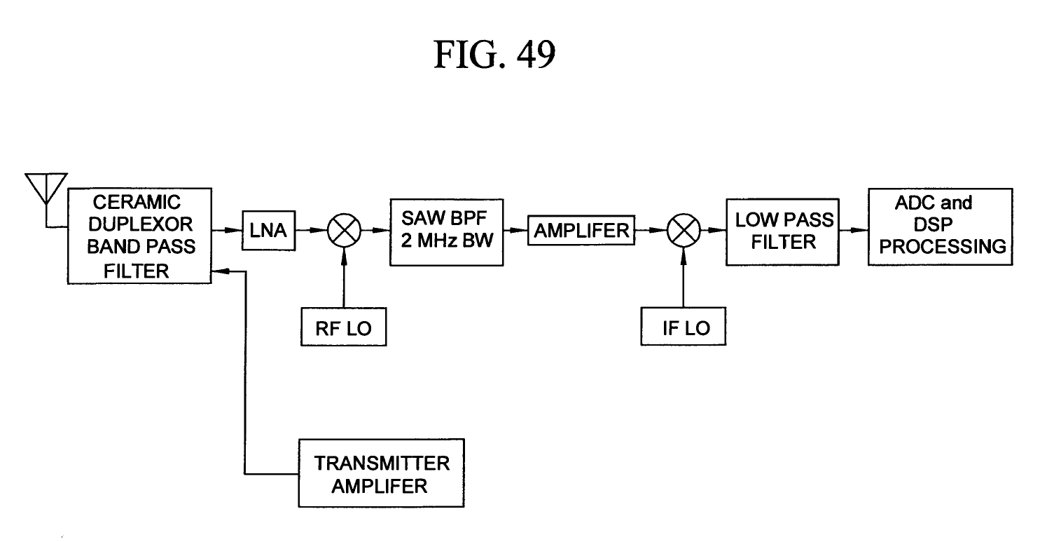

The typical wireless transceiver as found in a cellular telephone is based on a circuit structure as shown in FIG. 49. A superheterodyne structure is shown but, as would be understood by a person of skill in the art, there could be other options as well. In the superheterodyne structure, the duplexor filters out the transmitter signal from the receiver channel and also provides a convenient method of coupling the transmitter and receiver to the single port antenna. In the current art, the duplexor is a relatively large and expensive component of the wireless transceiver. The suppression of the transmit signal in the receiver path is required such that the signal input to the LNA is small and well within the region of linearity of the LNA. Otherwise intermodulation noise will occur that reduces the SNR of the demodulated signal.

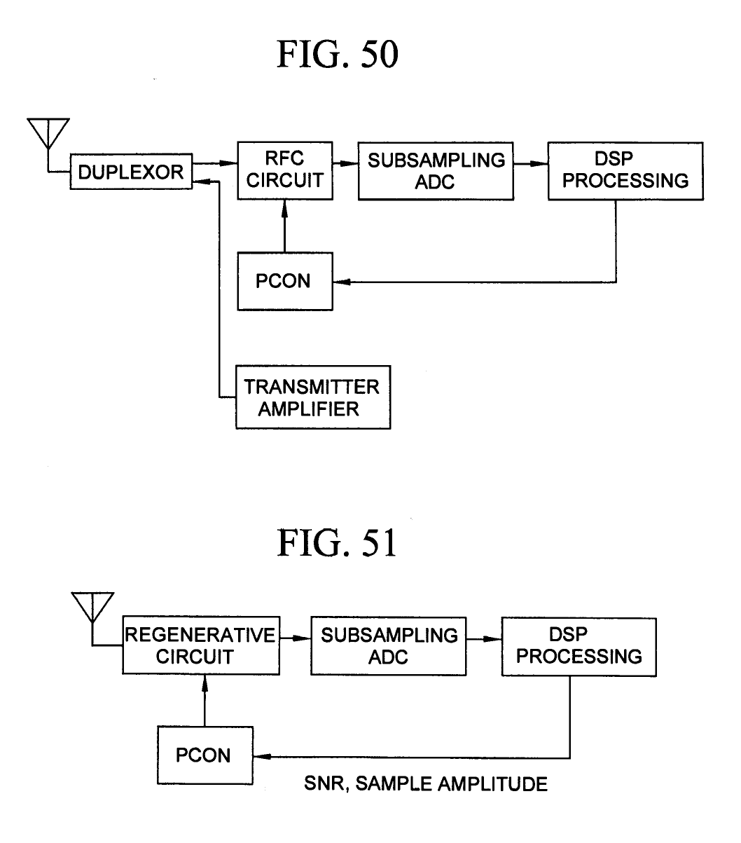

FIG. 50 shows the implementation of the wireless transceiver based on the RFC. Note that a duplexor is still required as in FIG. 4, however, the filtering requirements are significantly less stringent as the RFC component is a very narrowband filter that essentially blocks the transmitter signal from entering the receiver path. Hence the duplexor block in FIG. 50 is more of a convenient method of coupling the transmitter and the receiver to the single antenna port. Note that the feedback information from the DSP processing that the PCON requires to set the parameters of the RFC is very similar to that of the GPS receiver based on the RFC discussed earlier. The inputs to the PCON in terms of SNR and signal sample amplitude are computed as part of the normal processing of the wireless signal demodulation and therefore no additional processing to accommodate the PCON is required. The algorithm for controlling the PCON can be a dithering process that maximizes the SNR of the received signal. Other methods can be used for the PCON as well.

### An Exemplary Implementation of the RFC in a Wireless Receiver

Superheterodyne (SH) receivers appear ubiquitously in cell phones, GPS receiver and wireless sensor devices. The entire SH receiver is tightly integrated on a mixed signal ASIC that is inexpensive to fabricate, robust and has performance close to the theoretical optimal bound. Monolithically integrated multiband SH receivers have also been created that have enabled highly complex multi-function transceivers currently developed by a multitude of handset manufactures around the globe.

However, the sheer volume of such receivers that are currently being manufactured for a variety of applications is staggering. As of 2007 there was already 1 mobile phone per every two inhabitants worldwide. With an average lifespan of 2 years this results in the current rate of several billion mobile devices per year being manufactured. In addition, GPS is experiencing a similar exponential growth rate in terms of the number of deployed receivers used by the general public and military. Recently, due to the near negligible cost of the RF receiver, there has been an explosive development in the area of wireless sensor and telemetry devices. Predictions are that the number of wireless sensors will soon dwarf the aggregate of mobile and GPS receivers currently deployed.

Such large volumes provides incentives for technology advancements cost reductions of the wireless receiver. Hence competing architectures to the SH are mounting. During the past decade the zero IF and near zero IF architectures have been extensively researched and engineered resulting in further cost reductions of the wireless receiver. The wireless receiver discussed herein (the RFC) provides for further potential cost reductions. In certain embodiments, the RFC eliminates several filtering components required in the other architectures that need to reside off-chip.

FIG. 51 shows the architecture of en exemplary RFC receiver. The signal from the antenna is fed directly into the RFC with an output that is digitized by the subsampling ADC. The digitized output is then processed by the DSP processor which demodulates the desired signal. Two outputs are provided for feedback which are the sample amplitude at the output of the ADC (input to the DSP) and the SNR. Both of these feedbacks are readily available from the DSP necessary to apply to the desired signal demodulation process and do not constitute additional processing. The parameters required to control the RFC are provided by the PCON block shown in FIG. 51. This takes the digital feedback from the DSP block and provides some further processing. The outputs of the PCON can be in the Pulse Width Modulated (PWM) signals that requires no additional DAC functionality. A simple first order low pass filter is sufficient to produce the analog parameter signals required by the RFC.

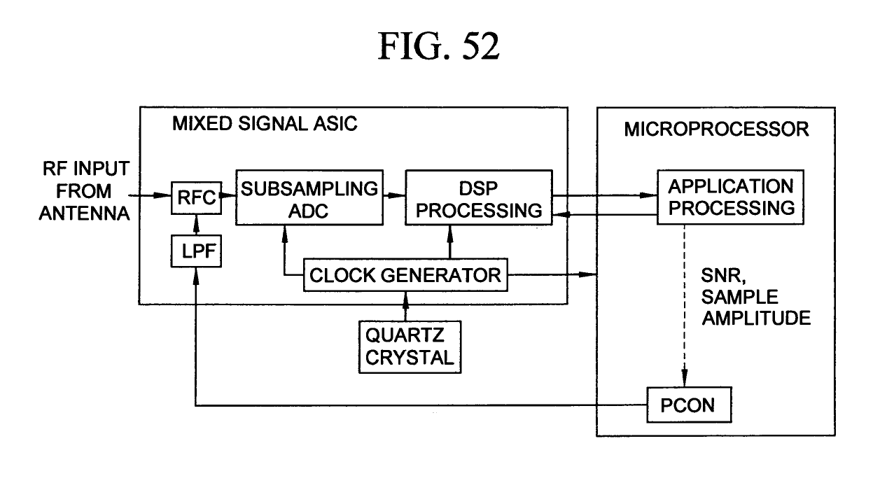

The integration of the RFC can be achieved monolithically on a mixed signal ASIC. A possible two chip implementation is shown in FIG. 52. The first chip is the mixed signal ASIC which contains the RFC, subsampling ADC and the DSP processing block which essentially performs the demodulation processing of the desired signal. This demodulation would involve, for example, the despreading operation of a spread spectrum modulation of a GPS or CDMA signal. The digital output of the DSP processing is made available to the microprocessor which runs the upper layers of the communication link protocol stack which includes the applications.

Note that the mixed signal ASIC does not require any off-chip components except for the quartz crystal which is necessary for any wireless receiver to generate sufficiently stable timing signals. The ASIC has a single RF analog input and a set of digital IO lines. The connection from the PCON to the mixed signal ASIC is a set of PWM digital lines and are not analog.

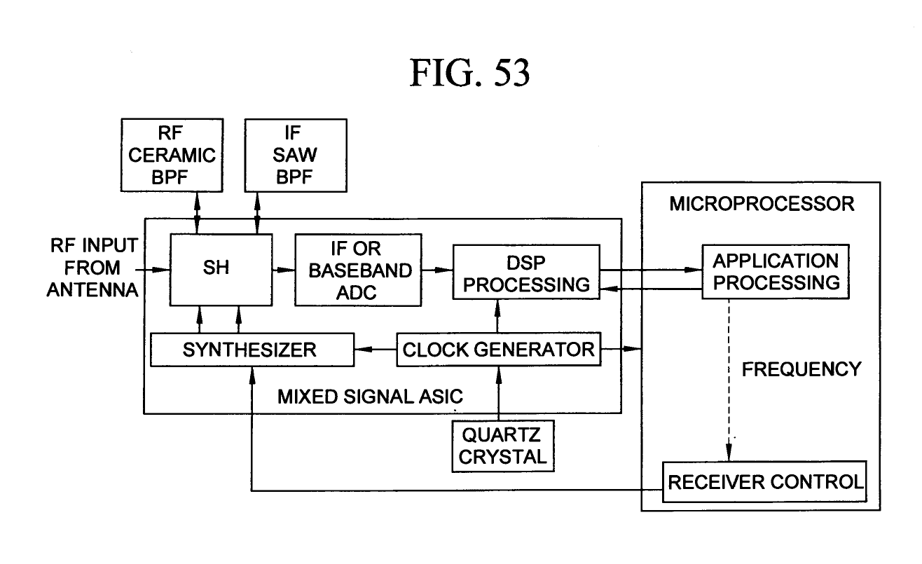

This exemplary two chip receiver implementation is standard and that there is no additional hardware complexity resulting from the RFC based architecture. In fact the RFC implementation makes the ASIC simpler in that off-chip SAW and ceramic filters are not required. FIG. 53 shows a typical implementation for a SH receiver. Note the two BPF's which need to be off chip. These are relatively expensive components and require signal buffering by the ASIC to drive these devices.

Regarding the internal ASIC circuitry, the SH implementation requires a synthesizer for the RF LO and the IF LO. It also requires the downconversion mixers. Careful design is necessary in order to avoid LO frequency spurs in the desired passband. As well the two downconversion mixers are inherently nonlinear and are a source of intermodulation distortion which limits the instantaneous dynamic range of the receiver. The RFC on the other hand is linear and therefore the dynamic range is potentially larger.

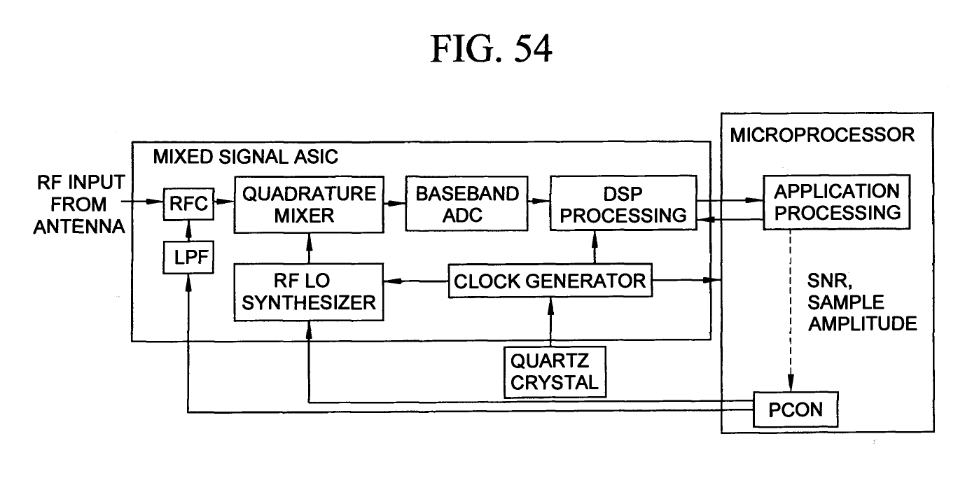

The RFC may require a sub-sampling ADC which can sample the narrow bandwidth signal at the carrier frequency but the sampling rate only has to be approximately equal to the signal bandwidth. Hence the sampling rate is potentially no different than that of the SH solution. Therefore the DSP involved in demodulation of the desired signal may be the same for the RFC and the SH. However, the high carrier frequency at the ADC input implies that a fast Sample and Hold (S&H) processing block may be placed prior to the ADC. Such S&H devices are currently available for analog signals beyond 20 GHz. Hence sampling of wireless signals below 6 GHz is certainly feasible. However there may be a challenge in realizing a S&H circuit that is of sufficiently low power consumption for the wireless application. In the meantime there is an alternative solution that gets around the problem of a suitable low power S&H. The solution is is based on a RFC with a zero IF solution as shown in FIG. 54. This alternative implementation requires an RF LO referenced from the same clock generator as before which feeds a quadrature mixer as shown. The zero IF I and Q quadrature channel outputs are digitized with the baseband ADC with the digital samples passed to the DSP component of the ASIC. Note in this application the S&H requirements are trivial.

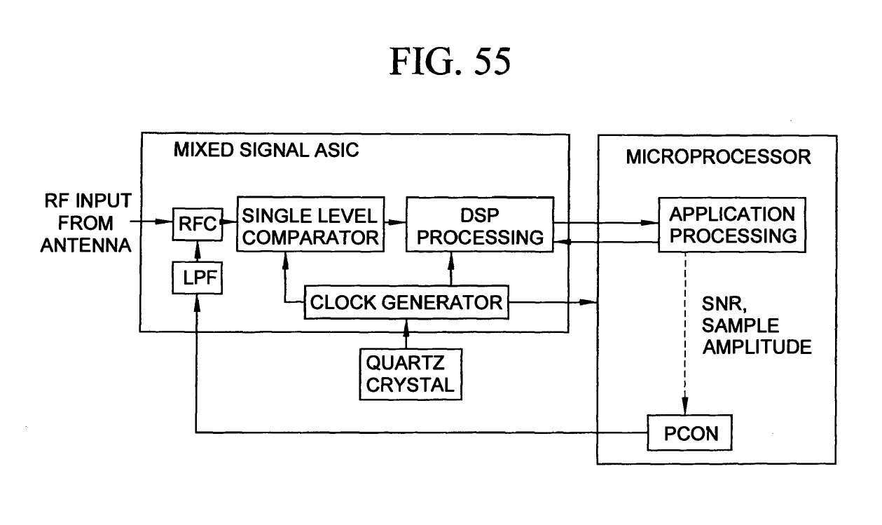

Another possible solution which avoids the S&H of FIG. 52 is to use a simple high speed one bit comparator instead of the ADC. Such a component design that meets the low power requirements is readily available. The block diagram of this implementation is shown in FIG. 55. The single bit ADC results in about a 2 dB loss in effective SNR, which decreases with oversampling. In many wireless applications, such a performance loss is of negligible consequence.

In certain embodiments, the RFC implementation results in a simpler receiver ASIC that may avoid off chip filtering components. The operation of the RFC may be somewhat more complex than the traditional SH implementation as the RFC parameters may need to be continually updated to mitigate drift issues. However, the demodulation processing typically performed in wireless receivers generates the signal amplitude and signal SNR measurements that are sufficient observables for controlling the RFC and maintaining optimal tracking of the desired signal. Hence, in certain embodiments, no additional computationally intensive processing is required to support the RFC. In certain embodiments, the processing required in the PCON is relatively low speed and easily absorbed into the processing already performed in the microprocessor.

In certain embodiments, there may be a potential realization complexity of sub sampling ADC required. However, this issue may be reduced by the following:
1. The RFC with the subsampling ADC may avoid the RF and IF synthesizers required otherwise. Hence the ASIC power consumption and complexity is reduced by this factor. Note that the implementation of the synthesizer generally results in on-chip interference issues that are difficult to solve and do impose design constraints and limitations.
2. S&H devices currently exist of adequate performance for the wireless receiver application. There is no physics limitation that precludes the implementation of a low power S&H suited for this application.
3. The zero IF is a workable compromise where an RF LO synthesizer is substituted for the S&H. Such a solution could also be a solution.
4. Another solution may be that a single bit ADC can be used which is merely a simple comparator device.

As discussed previously, the RFC has application in the implementation of the transceiver of the cellular phone. In certain embodiments, the RFC can eliminate various components of the traditional phone that are not possible to include in the main transceiver integrated circuit such as the duplexor and the SAW filter. The RFC provides a narrow bandpass filter commensurate with the bandwidth of the desired RF cellular signal that is to be demodulated eliminating the need for further analog filtering (RF and IF filtering in a superheterodyne architecture, RF and baseband filtering in a zero IF architecture). The output of the RFC filter can be input directly into a subsampling ADC with a sampling rate equal to the bandwidth of the RFC filter. The output stream of discrete time samples of the ADC output in certain implementations is further processed with DSP (digital signal processing) and then the encoded voice/data signal can be extracted and demodulated for use in the application layer of the cell phone.

The prior art receiver design based on frequency translation requires an accurate synthesizer to generate the appropriate local oscillator (LO) signals. These LO's are derived from a fixed temperature compensated quartz crystal oscillator. The small frequency errors of the LO's are generally compensated for directly in the DSP processing such that the analog portion is fixed. In some earlier implementations, the frequency of the quartz crystal oscillator could be adjusted over a small range (+−50 ppm) based on feedback from the signal demodulation. This is based on the frequency error being recognizable in the demodulated signal output which provided input to a frequency locking loop that controlled the exact frequency of the quartz crystal oscillator with a varactor diode coupled with the crystal circuit.

In the RFC implementation, the parameters may include:
Ain—input attenuation control
A—loop gain control based on a variable attenuator
D—loop delay or phase shift

These are set such that the RFC can realize the required center frequency, bandwidth and throughput gain to optimally select the desired cellular signal band. Examples would be for CDMA IS2000 a bandwidth of 1.2 MHz to about 5 MHz is required centered at the carrier frequency. GSM which is about 200 kHz but with frequency hopping. To facilitate the notation the following three attributes of the RFC bandpass filter response can be defined:
F—center frequency of bandpass response
B—bandwidth of bandpass response
G—throughput gain of overall bandpass filter

Setting these parameters (for the cell phone signal demodulation) is generally difficult due to the high gain and high Q filter response required. (Q in this context refers to the ratio of the center frequency of the band pass filter to its bandwidth). For the IS2000 CDMA signal in a PCS band (F˜1900 MHz, B˜1 MHz), a Q of about 2000 is needed. Furthermore, the signal can be as small as −120 dBm which will require a gain of over 100 dB between the antenna and the ADC input. Furthermore this gain has to be tightly controlled to stay within the dynamic range of the ADC. For example if a 4 bit ADC is used then the amplitude control of G has to range over 70 dB with an accuracy of 1 dB.

A higher order ADC would relax this specification but this would significantly inflate the power consumption of the ADC operation as well as the expense of integrating this component.

A receiver based on the RFC architecture can provide the same signal selectivity and noise figure performance as a superheterodyne architecture. In certain embodiments, an advantage of the RFC (in the cell phone context) is a savings in terms of implementation. This is based on the possibility of implementing the RFC monolithically without the need of external parts as is required for prior art designs. This can map into significant savings in this high volume market.

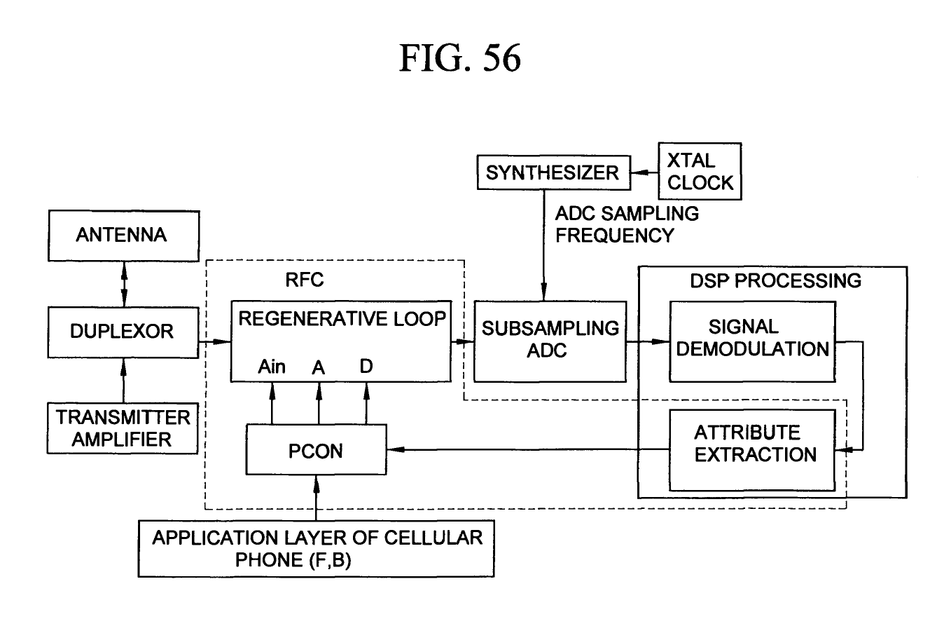

An exemplary RFC circuit in the cellular phone context is shown in FIG. 56. In FIG. 56, the antenna feeds into a duplexor which is a means of combining the transmitter output and the receiver input ports to the single port antenna. The duplexor with the RFC does not have to be as elaborate in terms of filtering selectivity between the transmitter and receiver bands as in the prior art as much of the receiver filtering is achieved by the regenerative loop as part of the RFC. The RFC is comprised of the regenerative loop, PCON and the attribute extraction component of the DSP processing. The receiver port output of the duplexor feeds into the regenerative loop component of the RFC which performs the narrow bandwidth filtering at the RF frequency necessary to select the desired signal. The output of the regenerative loop is digitized in the sub-sampling ADC (sampling rate based on B and not F). The output samples of the ADC are processing in the signal demodulation block as part of the DSP resulting in outputs that are useful for signal attribute extraction. The measured signal attributes are used by the PCON to generate the Ain, A and D controls for the regenerative loop. The PCON also takes initial inputs from the application layer of the phone which dictates the desired F and B parameters. In the case of frequency hopping F can be construed as a sequence corresponding to the frequency hopping sequence of the desired signal which is known by the receiver via the application layer processing. The remaining G attribute is determined indirectly by the DSP processing as it depends on the current signal strength not known to the application layer.

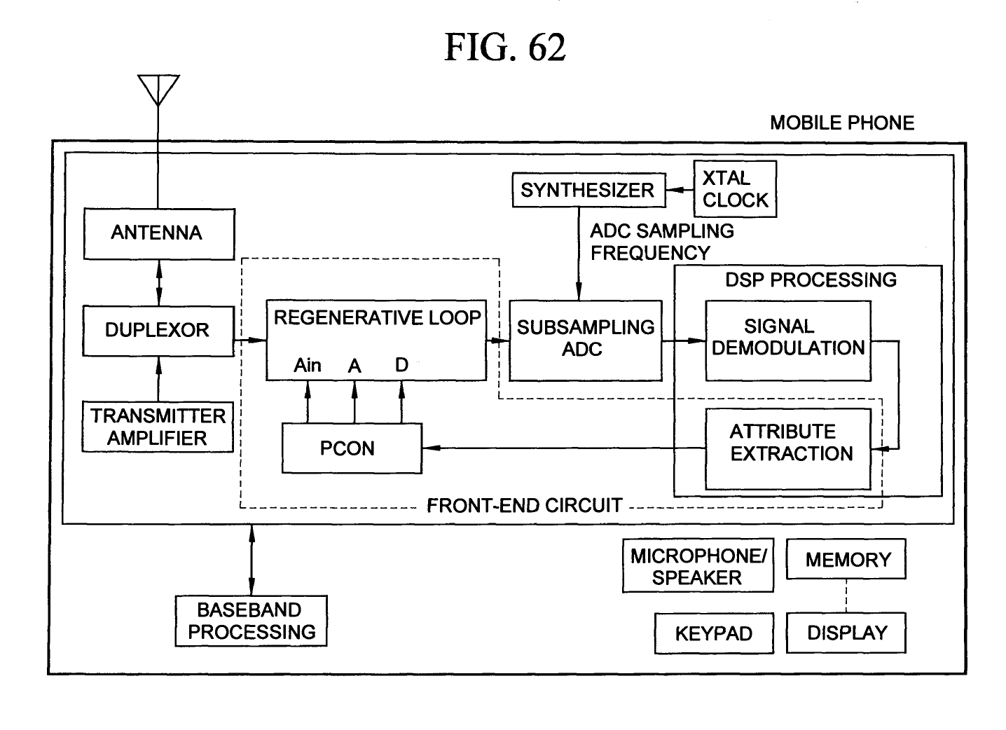

FIG. 62 depicts a block diagram of a regenerative feedback circuit, like the circuit described with respect to FIG. 56, implemented in a front-end circuit of a mobile telephone. As shown, the front end includes a regenerative feedback circuit for transmitting and receiving signals via the antenna. In FIG. 62, the front-end also includes a duplexer and a power amplifier.

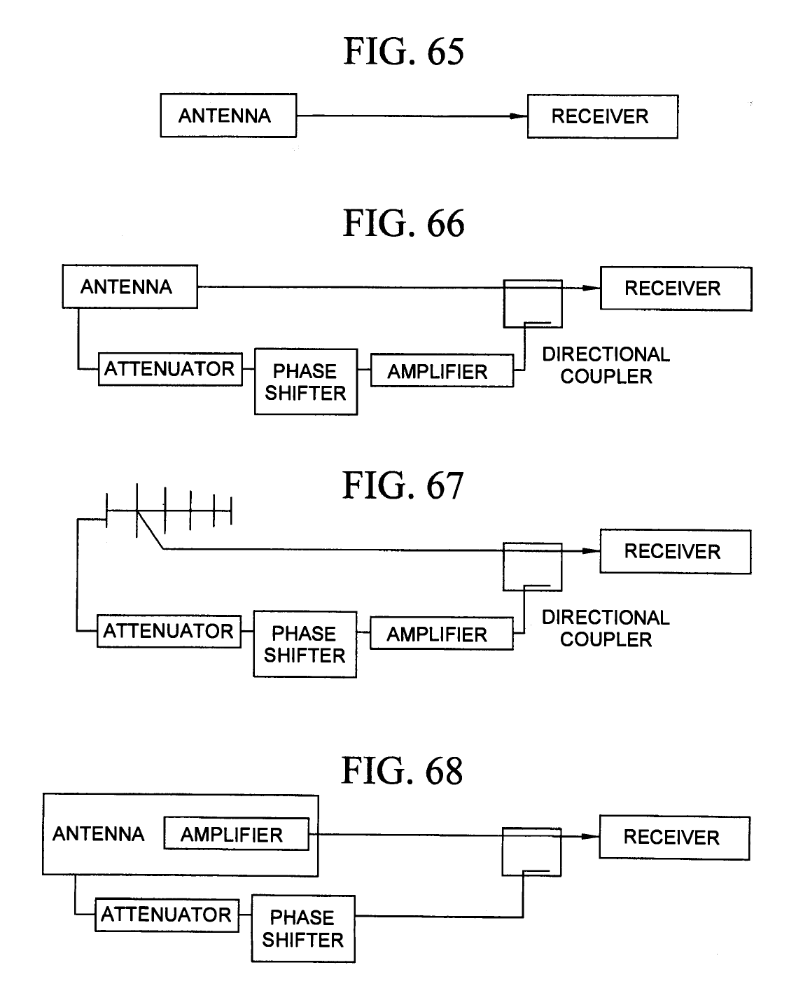

Although the embodiments above describe an antenna coupled to a receiver (e.g., an RFC) as illustrated in FIG. 65, in some embodiments, the RFC may also be used with an antenna as shown in FIG. 66. FIG. 66 comprises a feedback consisting of a standard directional coupler that couples a portion of the receiver signal back to the antenna through a series connected amplifier, phase shifter and attenuator. As discussed throughout the specification, the phase shifter and attenuator are controllable as part of the RFC. In some embodiments, the controlled feedback signal coupled into the antenna may have substantially the same phase and amplitude as the desired incoming signal captured by the antenna. In some embodiments, the result of this controlled feedback may be a high Q resonance loop that is frequency selective. The receiver may be a conventional receiver or any of the types described herein. In either case, the Q enhanced antenna provides a narrow bandwidth response controllable by the receiver which may be an RFC front end.

In some embodiments, the antenna may be a yagi antenna and the resulting configuration may be as shown in FIG. 67. As discussed above, the receiver may be a conventional receiver or any of the types described herein.

In some embodiments, the antenna may be an active antenna. FIG. 68 illustrates an embodiment of such an active antenna. In this case, since the active antenna includes an amplifier, the amplifier illustrated earlier in the feedback look may not be required.

The PCON comprises various processing blocks and algorithms to facilitate the functionality required for the cell phone application. Exemplary embodiments of these components and algorithms are described below.

### Algorithms of the PCON

### LUT (Look Up Table)

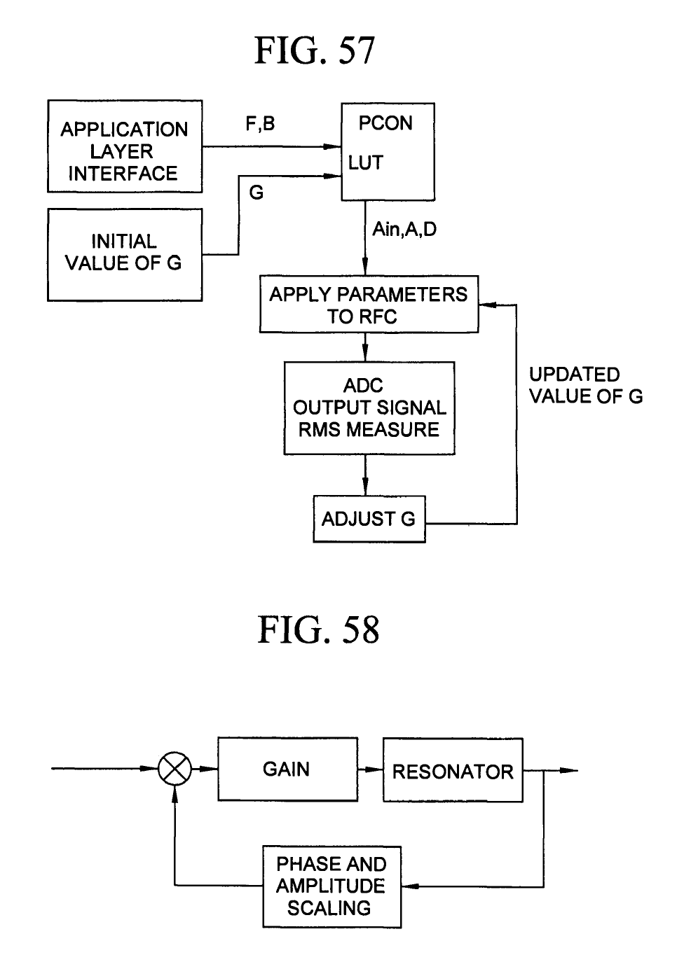

Ideally, if the components of the regenerative loop are perfectly stable such that G, F, B maps exactly into Ain, A, D via an open loop calculation done by the PCON then no corrective feedback from the DSP would be required. In this case the setting of G, F, B can be done with a LUT where the addressing of the LUT entry is based on the F, B, G input. F and B come directly from the application layer. G will have to still come from the DSP block. Hence the procedure, which is illustrated in FIG. 57 may be as follows:
1. F and B issued by the application layer to the PCON
2. G is set to a nominal value dependent on the expected value of the signal strength of the desired signal
3. PCON uses FBG to compute an address of the entry in the LUT. The entry consists of the parameters Ain, A, and D.
4. With B and G assumed to be accurate, the desired signal is demodulated in the DSP. An immediate output of the DSP is the signal level of the ADC output. If it is too high the ADC will be saturated, if it is too low then the quantization noise of the ADC processing will dominate. Hence the signal RMS (root mean square) level must be close to a certain target level. The RMS measurement is passed to the PCON which determines the appropriate correction to G.
5. Repeat 4 indefinitely

As observed F and B are open loop parameters set by the application layer through the PCON and the G attribute is set iteratively based on a gain control loop. There are numerous variations for this gain control depending on the propagation environment. For example, an indoor environment may change much slower than an outdoor environment (e.g., driving on the freeway through an urban corridor type environment). The phone can track the signal fluctuations and determine how quickly it needs to respond.

In a frequency hopping application where F changes according to a known pseudo random sequence every few milliseconds, the LUT entry will be accurate and can be used open loop. Say a GSM signal is tracked by the receiver where F is continually hopped in this fashion. Then the LUT entry may need to be used open loop as there may not be any time for further adaptation. However, the LUT entries can optionally be adapted over a longer term by noting errors after each frequency hop. Minor incremental adjustments can be done to the table over the use of several minutes.

Also in the prior art is the use of a temperature sensor which can be integrated together with the LUT. The address of the LUT is then determined from the F, B, G attributes as well as the temperature output of the co-located sensor.

An additional output of the DSP which is generally computed as part of the normal physical layer functionality of the cell phone is the estimation of the signal to noise ratio (SNR) of the demodulated signal. This is used by the phone to determine if and when to handoff to the next base station. Typically the SNR estimates generated by the cell phone are transmitted back to the base station which facilitates these network based decisions.

It can therefore be assumed that such generated SNR measurements are available to the PCON without further processing required. In certain embodiments, an objective of the PCON is to optimize the SNR by dithering the parameters of Ain, A, D of the regenerative loop. In particular the center frequency and bandwidth of the regenerative loop are sensitive to A and D. Hence the objective is to optimize A and D for a given F and B corresponding to the desired signal by maximizing SNR. The optimized A and D values can then be used to refine the LUT.

### Cold Start of the RFC

A challenge with the monolithically integrated RFC implementation in the cell phone application is that of a robust cold start algorithm. This is where the RFC circuits are initially turned on and the LUT entries are not of sufficient accuracy to map B F G into the parameters Ain, A, D. The LUT is used to set up the initial guess, but a fast robust refinement is required to demodulate the desired signal. Here two modes may be possible which are described below. The first mode is direct but it may not be successful if the tolerances of the monolithic integration are not commensurate with the accuracy requirements of the RFC.
Cold start-mode I—The FB inputs from the application layer, the nominal guess at G from the PCON and the temperature reading are used to address the LUT as described before. The RFC is set according to the Ain, A, D parameter entry of the LUT and the signal is demodulated. G is corrected based on the RMS of the raw ADC samples. The frequency error is determined in the DSP (note may only work if the F offset is small relative to B). Next B is corrected based on the estimated SNR samples from the DSP.
Cold start-mode II—If the LUT is too inaccurate for the setting of Ain, A, D then the following procedure may be utilized. This procedure is also of value in the factory where the LUT entries are initially determined. Assume a desired signal has the frequency and bandwidth of F and B. As the desired signal is coded in a unique way that differentiates it from the other wireless signals present and that this code is known to the receiver, it is reasonable to assume that the SNR and frequency offset as measured by the DSP can be used to accurately tune the LUT entries. Assuming that the desired signal is available to the receiver then the following procedure may be performed:
   1. Ain set to maximum attenuation such that no signal comes into the RFC
   2. D is arbitrarily set to the middle of the range and A is adjusted such that the output of the RFC begins to oscillate. The oscillation condition can be sensed as the RMS output of the ADC will show the presence of a signal. The ADC sampling frequency is set by a quartz crystal oscillator that is scaled to the appropriate frequency by a synthesizer as shown in FIG. 56. This frequency is f_{smp,1}. The output samples of the ADC can determine the frequency of the RFC oscillation but there is an ambiguity as the set of frequencies of f_{bbc}+c₁f_{smp,1} where c₁ is and integer, cannot be resolved. Consider another frequency generated by the synthesizer of f_{smp,2}. The unresolved set of frequencies is f_{bbc}+c₂f_{smp,2} where c₂ is an integer. If f_{smp,1} and f_{smp,2} are selected appropriately (i.e., no overlapping harmonics) then there will only be one possible frequency that is common to both ambiguity sets. This is then the frequency of the RFC or f_{bbc}.
   3. Having a means of measuring f_{bbc}, D is adjusted such that f_{bbc}=F. Note that the accuracy of this is limited to the accuracy of the crystal oscillator used to generate f_{smp,1} and f_{smp,2}. Typically this will be about 10 ppm such that at the cellular frequency the offset will be about 10 kHz. However, this is well within the bandwidth of the desired signal and is therefore not an issue as it can be adjusted precisely in a later step.
   4. Having set D such that the frequency is approximately correct, A is adjusted such that the sinusoidal signal is extinguished. This is observed based on the RMS feedback from the ADC. Note that the further the signal is extinguished the broader the bandwidth will be (poles of the regenerative loop are moving away from the jw axis further into the left hand plane). Having too narrow a bandwidth will result in perhaps not seeing the desired signal as it is attenuated by the narrow bandwidth filter shape of the RFC and the possibility that the center frequency may be off by up to 10 kHz. Fortunately the sensitivity of the A control in this regard is easily established as part of the receiver ASIC design and foundry fabrication process. Hence it can be assumed that A is adjusted until the RMS reading becomes zero and the adjusted a further increment in the same direction to set the bandwidth appropriately.
   5. Now with A and D set such that the RFC filter has the approximate B and F attributes for the desired signal, Ain is adjusted to let the antenna signal in. Ain is adjusted until the RMS level is nominal. 6. All three controls, A,D and Ain are then dithered until the SNR is maximized.

The optimization is convex in the neighborhood of the ideal setting of A D and Ain with SNR as the optimization objective and hence this fine convergence step is straight forward and can be implemented by several well known methods. The simplest method is to adjust one parameter at a time as follows: 1) Maximize SNR with A and D fixed and Ain variable. 2) Maximize SNR with A and Ain fixed and D variable. 3) Maximize SNR with Ain and D fixed and A variable. A faster method is to determine the gradient of SNR relative to the three variables of A, D and Ain. Then take a step along the maximum gradient direction and repeat. The partial derivatives required for this method are determined numerically by small dithering steps.
7. When the optimization is complete, place A, Ain,D in the LUT.

Another innovative feature is the estimation of the frequency of the RFC oscillation based on selecting two ADC sampling frequencies derivable from the crystal oscillator. Consider that the RFC oscillation frequency in the range of 100 MHz to 2 GHz. The sampling frequencies for the ADC are 2.017 MHz and 2.013 MHz selected for this example arbitrarily. Other pairs of frequencies are also possible. First the aliased frequencies that show up in the sampled output are

f₁=mod(fᵢₙ,2.017)

f₂=mod(fᵢₙ,2.013)

The processing computes the sets of possible input frequencies as

f_{in,1}=f₁+i2.0017

f_{in,2}=f₂+j2.0131

where i and j are integers. From these two sets we find frequencies that are common within 1 kHz. The 1 kHz range is due to the assumption of a 1 msec observation time of the ADC output samples.

### Estimation of the SNR

The estimation of the SNR may be highly dependent on the structure of the modulation of the desired signal. One example is for IS2000 CDMA where the pilot signals are demodulated and a SNR is estimated based on the set of pilot signals used and the number of significant multipath components that are demodulated. Fortunately all of this processing is already implemented as part of the necessary CDMA signal demodulation with no additional processing components required to facilitate the SNR estimate as required for the RFC. One issue could be that the estimate of the SNR is generally averaged over a longer time constant than is necessary for the RFC cold start and tracking processes. However, the pilot signal estimates are available which are updated on the order of several milliseconds commensurate with the time constant associated with the fastest fluctuating multipath that the receiver is likely to experience.

These pilot signal estimates are easily combined to provide an appropriate metric suitably equivalent to the desired SNR metric.

Other modulation schemes contained in WiFi, WiMAX and 802.11 variants all have some form of embedded pilot signal from which the SNR can be appropriately estimated. GSM uses a segment of pilot within the transmitted signal burst. In cases where the wireless signal does not use pilot signals there are other means of estimating the SNR. Decision feedback can be used where the SNR is determined based on the variations of the signal relative to the expected (noise free) signal.

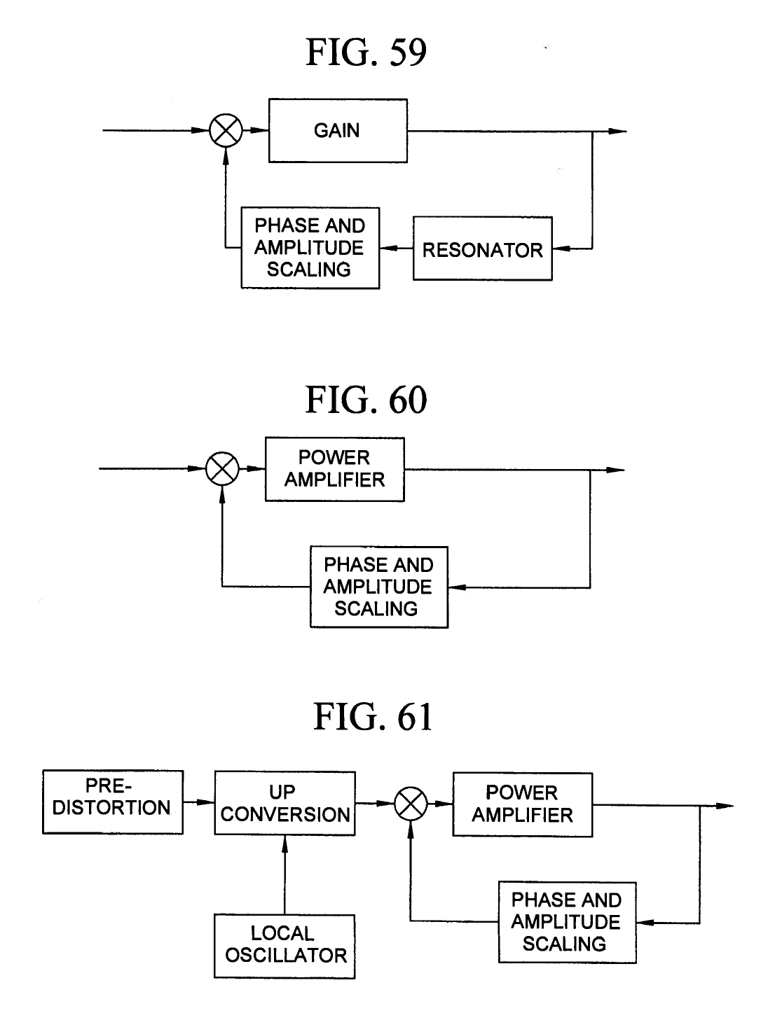

As shown in FIG. 58 and FIG. 59, in certain embodiments at least one of the first path or the second path of the regenerative feedback circuit further may include a resonator circuit.

As shown in FIG. 60 and FIG. 61, in certain embodiments the a power amplifier may be connected to the output of the regenerative feedback circuit or connected within the first path of the regenerative feedback circuit for amplifying an electrical signal for, for example, transmission of the electrical signal.

### Additional Embodiments

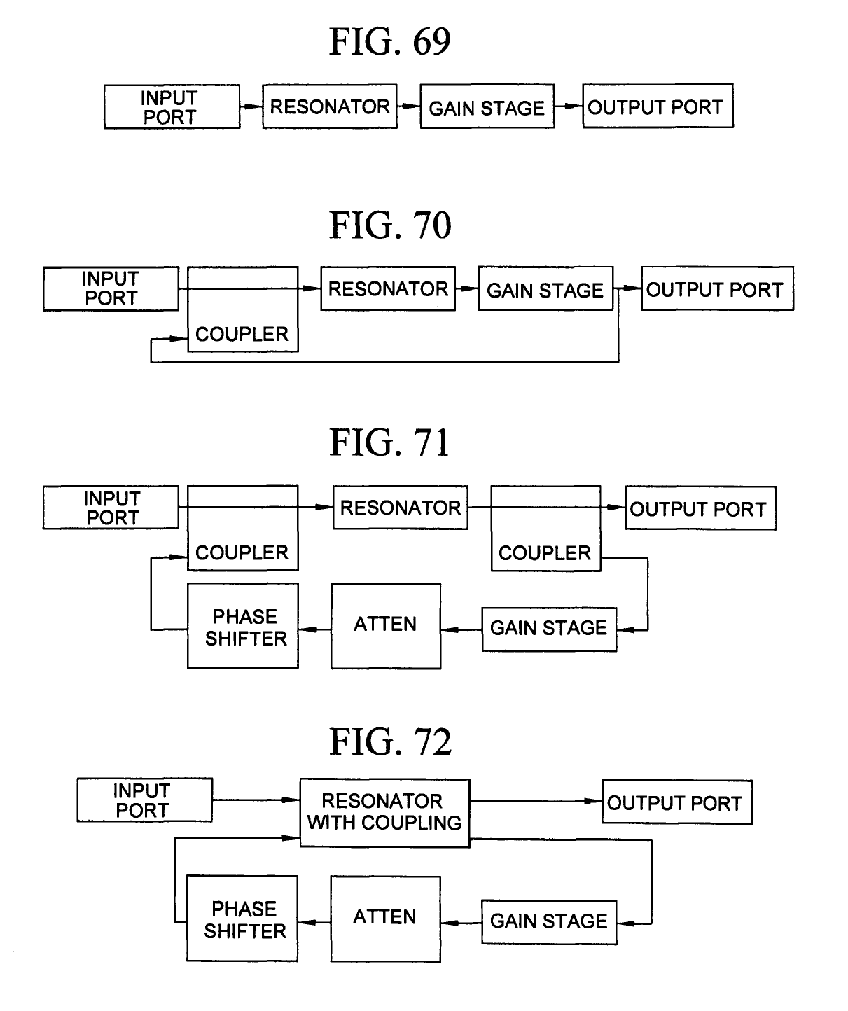

In some embodiments, the RFC may also be used to improve the performance of a resonator. A typical narrowband receiver with a resonator circuit is illustrated in FIG. 69. With feedback, the Q of the resonator can be significantly improved. The feedback is illustrated in FIG. 70. If the phase and attenuation of the feedback path are controlled with an RFC as shown in FIG. 71, the position of the resonance response can also be controlled. FIG. 72 illustrates a resonator with a coupling port. In an embodiment the ported resonator may be a waveguide cavity, a dielectric puck resonator, or a travelling wave resonator. In some embodiments, the gain stage may be in the feedback path so the loop gain with the coupling losses is close to unity. In some embodiments, this configuration may help to achieve Q enhancement.

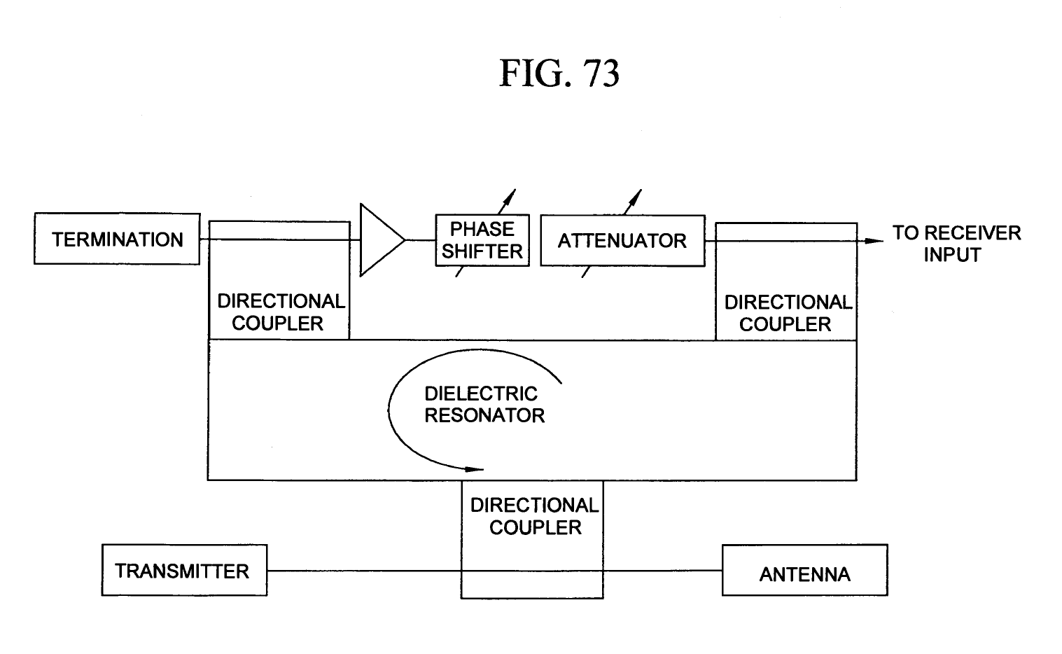

In some embodiments, the RFC may also be used in conjunction with bi-directional filters. An example of such a use is depicted in FIG. 73. In the circuit in FIG. 73, the transmit and receive signals pass through the same antenna (but multiple antennas could also be used). However, the transmit signal is isolated from the receiver port which in some embodiments, may be achieved with a circulator. In some embodiments, the circulator may be based on a ferrite device which has a limited isolation, bandwidth and power handling capability. The circuit depicted in FIG. 73, however, avoids the performance limited circulator by using a three port resonator with directional couplers at each port to provide the substantially similar functionality to that of a circulator. In some embodiments, the resonator may be implemented as a dielectric puck with three coupling ports spaced at about 120 degrees of separation as shown in FIG. 73. Other resonator types may include, for example, a ‘rat race’ microstrip circuit.

In the circuit for FIG. 73, a portion of the transmit signal from the transmit power amplifier is coupled into the circulator on route to the common antenna. The signal is then coupled out of the resonator into the RFC and to the receiver. The coupled output of the circulator at the output of the RFC is combined with the output of the RFC which is adjusted in phase and amplitude by the RFC such that it cancels the transmit signal at the input to the receiver port. The receive signal from the antenna gets coupled into the resonator differently (as it propagates in the opposite direction) such that it is not cancelled at the input port of the receiver in the same manner as the transmitted signal. This circuit may be useful in, for example, high power CW (continuous wave) radars, for bi-directional or full duplex communication channels operated at the same frequency for transmit and receive.

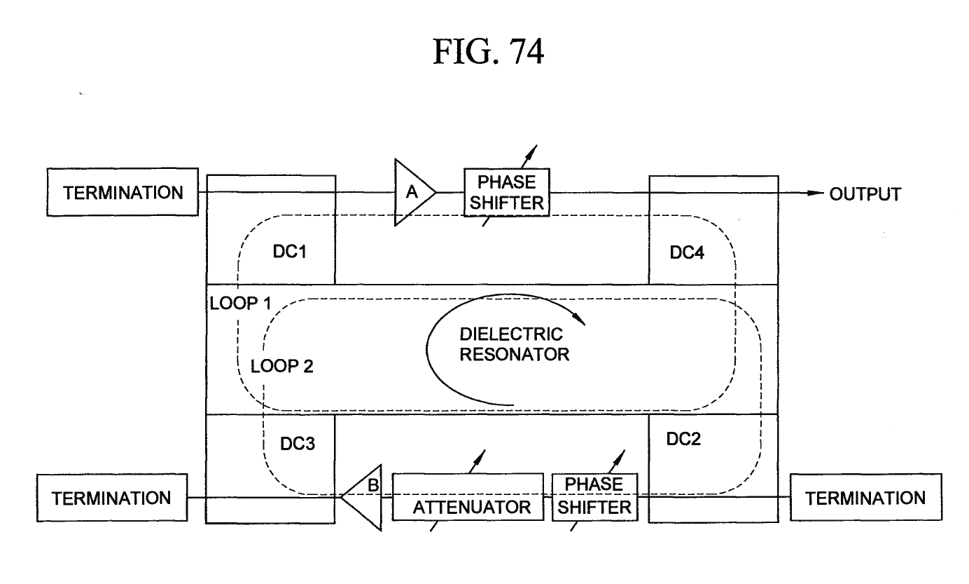

In some embodiments, the RFC may also be used in conjunction with oscillators (e.g., ultra stable oscillators). An example of such a use is depicted in FIG. 74. The circuit in FIG. 74 consists of two coupled oscillators. The first oscillator consists of the loop of amplifier A, the directional coupler DC1, the resonator, the directional coupler DC4, and the phase shifter. In operation, the directional coupler DC1 couples some of the output signal into the resonator and DC4 couples the signal out of the resonator back into the amplifier via the phase shifter. In some embodiments, the phase shifter may be set so that the oscillator frequency is coincident with the resonance frequency of the resonator. The other oscillator loop consists of the amplifier B, DC2, the common resonator, DC3, and the phase shifter and attenuator. This feedback look constitutes an RFC. In operation, the RFC of the second oscillator sets the frequency of the oscillator. In turn, the first oscillator, which is coupled to the second oscillator via the resonator, oscillates at substantially (or in some embodiments, exactly) the same frequency. The second oscillator limits the amplitude of the oscillation and provides for high reactive energy in the resonator which increases the stability of the overall coupled oscillator. The first oscillator operates with lower power through the amplifier A thus achieving low harmonics with the amplitude stability resulting from the limiting action of the oscillator 2 with the RFC.

Accordingly, the RFC can be used in the above oscillator structure in which two feedback loops pass through a common resonator. As described above, one loop acts as a higher power pump oscillator with an amplitude limiting action where the frequency control is provided by the RFC. The other loop is a low power loop with the gain stage in the loop operating on small signal levels well within the linear range of the amplifier. Hence a highly linear output response is generated with this circuit.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

1. A monolithic integrated circuit comprising:
an input for receiving an electrical signal;
a first path having a signal input for receiving the unfiltered signal, a signal output, and an adjustable first path signal scaling block;
a second path connected to the first path between the signal input and the signal output, the second path having an adjustable delay element and an adjustable second path signal scaling block; and
a fixed gain block located in the first path and connected between a second path input and a second path output connected to the first path;
wherein, the monolithic integrated circuit is configured to communicate with:
a detector connected to the signal output for detecting properties of an output signal; and
a controller connected to adjust the delay element, the second path signal scaling block, and the first path signal scaling block based on the properties detected by the detector to control the filtering and amplifying characteristics of the front end circuit.

2. A mobile telephone comprising:
a transmit/receive switch;
a subsampling analog-to-digital converter; and
a front-end circuit coupled between the transmit/receive switch and the subsampling analog-to-digital converter, for filtering and amplifying an unfiltered signal, the front-end circuit consisting essentially of:
a regenerative feedback circuit comprising:
a fixed gain block;
an input attenuation control;
a loop gain control;
a loop delay; and
a controller connected to adjust the input attenuation control, the loop gain control and the loop delay based on the properties measured by a detector to control the filtering and amplifying characteristics of the front end circuit;
wherein at least the input attenuation control, the loop gain control and the loop delay are located on the same monolithic integrated circuit as the fixed gain block.

3. An apparatus for processing an electrical signal, the apparatus comprising:
a front-end circuit consisting essentially of:
a first path having a signal input for receiving an unfiltered signal, a signal output, and an adjustable first path signal scaling block;
a second path connected to the first path between the signal input and the signal output, the second path having an adjustable delay element and an adjustable second path signal scaling block;
a fixed gain block located in the first path and connected between a second path input and a second path output connected to the first path;
a detector connected to the signal output for detecting properties of an output signal; and
a controller connected to adjust the delay or phase shifting element, the second path signal scaling block, and the first path signal scaling block based on the properties detected by the detector to control the filtering and amplifying characteristics of the front end circuit;
wherein at least the delay element, the second path signal scaling block, and the first path signal scaling block are located on the same monolithic integrated circuit as the fixed gain block.

4. The apparatus of claim 3, wherein the apparatus is at least one of a mobile telephone, a GNSS receiver, a wireless device, a wireless sensor, a monolithic integrated receiver circuit, a monolithic integrated transmitter circuit, and a monolithic integrated transceiver circuit.

5. The apparatus of claims 3-4, further comprising a transmit/receive switch, wherein the front-end circuit is connected to the transmit/receive switch.

6. The apparatus of claims 3-5, wherein at least one of the first path or the second path of the regenerative feedback circuit further comprising a resonator connected to the regenerative circuit.

7. The apparatus of claims 3-6, further comprising a power amplifier connected to at least one of the output of the front end circuit or within the first path of the front end circuit for amplifying an electrical signal for transmission.

8. The apparatus of claims 3-7, wherein the electrical signal is encoded with digital information.

9. The apparatus of claims 3-8, wherein the filtering and amplifying characteristics comprise the gain of the front-end and the bandwidth and center frequency selected for filtering an incoming signal.

10. The apparatus of claims 3-9, wherein the second path is a feedback path.

11. The apparatus of claims 3-10, further comprising multiple first paths connected to corresponding feedback paths, the first paths being connected in parallel between the signal input and the signal output.

12. The apparatus of claim 11, wherein one or more of the multiple first paths further comprise:
a feed-forward path connected to the first path upstream from the feedback path and an output connected to the first path downstream from the feedback path; and
a first path delay or phase shifting element connected between the input of the feed-forward path and an output of the feedback loop, the first path delay or phase shifting element being adjustable and connected to the controller, the controller being connected to adjust the first path delay or phase shifting element to achieve the desired signal output.

13-46. (canceled)

47. A monolithic integrated circuit comprising:
an input for receiving an unfiltered, unamplified signal; and
an output for outputting a filtered and amplified version of the input signal;
wherein the monolithic integrated circuit exhibits a bandpass frequency response with a Q value greater than 500, where the center frequency of the bandpass filter can be adjusted to multiple frequencies within a predefined range exclusive of a local oscillator.

48. An apparatus comprising:
a front-end circuit;
wherein the front-end circuit is implemented in a monolithic integrated circuit.

49. An apparatus comprising:
a front-end circuit;
wherein the front-end circuit is implemented exclusive of a ceramic-filter or a SAW.
